(19) United States
(12) Patent Application Publication
(10) Pub. No.: US 2025/0320927 A1
(43) Pub. Date: Oct. 16, 2025

(54) FLUID CONTROL VALVE

(71) Applicant: DENSO CORPORATION, Kariya-city (JP)

(72) Inventor: Ryo NOMURA, Kariya-city (JP)

(21) Appl. No.: 19/248,127

(22) Filed: Jun. 24, 2025

Related U.S. Application Data
(63) Continuation of application No. PCT/JP2023/042907, filed on Nov. 30, 2023.

(30) Foreign Application Priority Data
Dec. 28, 2022 (JP) 2022-212180

(51) Int. Cl. F16K 11/083; F16K 27/06

(52) U.S. Cl. CPC F16K 11/0836; F16K 27/062

(57) ABSTRACT

A housing rotatably accommodates a valve and includes a port that passes through an outer wall and an inner wall. A seal member is provided between the inner wall and the valve and includes a surface on the housing side that is in contact with a port periphery of the inner wall of the housing, and a surface on the valve side that is in sliding contact with the side wall of the valve. The biasing member biases the valve toward the apex of the conical shape and, during both the rotation and stop of the valve, keeps a state in which the side wall of the valve and the seal member are in sliding contact with each other, and keeps a state in which the inner wall of the housing and the seal member are in contact with each other.

### CROSS REFERENCE TO RELATED APPLICATION

The present application is a continuation application of International Patent Application No. PCT/JP2023/042907 filed on Nov. 30, 2023, which designated the U.S. and claims the benefit of priority from Japanese Patent Application No. 2022-212180 filed on Dec. 28, 2022. The entire disclosures of all of the above applications are incorporated herein by reference.

### TECHNICAL FIELD

The present disclosure relates to a fluid control valve.

### BACKGROUND

Conventionally, a fluid control valve that controls a flow of a fluid by switching communication and interruption between a plurality of ports provided in a housing is known.

### SUMMARY

According to an aspect of the present disclosure, a fluid control valve comprises: a valve having a side wall along a side surface in a conical shape and a flow path recessed from the side wall toward an axis of the side wall in the conical shape; a housing rotatably accommodating the valve about an axial center of rotation that is the axis of the conical shape, the housing having a port that passes through an outer wall and an inner wall; and a seal member provided between the inner wall of the housing and the valve, the seal member having a surface on a housing side and in contact with a port periphery of the inner wall of the housing and a surface on the valve side in sliding contact with a side wall of the valve. The fluid control valve further comprises: a biasing member biasing the valve toward an apex of the conical shape of the valve. The biasing member may be configured to, during both rotation and stop of the valve, keep the side wall of the valve and the seal member in sliding contact with each other, and keep the inner wall of the housing and the seal member in contact with each other.

### BRIEF DESCRIPTION OF DRAWINGS

FIG. 1 is a front view of a fluid control valve according to a first embodiment.

FIG. 2 is a side view in a direction II of FIG. 1.

FIG. 3 is a plan view in a direction III of FIGS. 1 and 2.

FIG. 4 is a cross-sectional view taken along line IV-IV in FIG. 3 without an actuator.

FIG. 5 is a side view illustrating only the valve of the fluid control valve.

FIG. 6 is a front view illustrating only the housing of the fluid control valve.

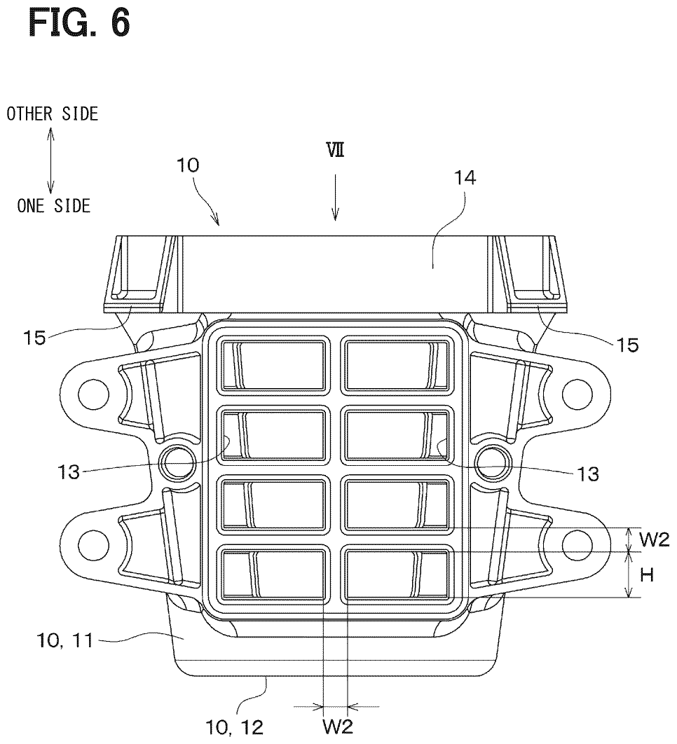

FIG. 7 is a plan view in a direction VII of FIG. 6.

FIG. 8 is a cross-sectional view taken along line VIII-VIII of FIG. 1.

FIG. 9 is an enlarged view of a portion IX in FIG. 8.

FIG. 10 is a perspective view illustrating only the seal member in a removed state from the housing.

FIG. 11 is a perspective view illustrating only a seal member in an assembled state to the housing.

FIG. 12 is a plan view illustrating a state in which the housing and the seal member are assembled.

FIG. 13 is a cross-sectional view of a fluid control valve according to a second embodiment.

FIG. 14 is a cross-sectional view of a fluid control valve according to a third embodiment.

FIG. 15 is a cross-sectional view of a fluid control valve according to a fourth embodiment.

FIG. 16 is a cross-sectional view of a fluid control valve according to a fifth embodiment.

FIG. 17 is a cross-sectional view of a fluid control valve according to a sixth embodiment.

FIG. 18 is a cross-sectional view of a fluid control valve according to a seventh embodiment.

FIG. 19 is a front view of a fluid control valve according to an eighth embodiment.

FIG. 20 is a plan view in a direction XX of FIG. 19.

FIG. 21 is a cross-sectional view taken along line XXI-XXI of FIG. 20.

FIG. 22 is a cross-sectional view of a fluid control valve according to a ninth embodiment.

FIG. 23 is a cross-sectional view taken along line XXIII-XXIII of FIG. 22.

FIG. 24 is a cross-sectional view of a fluid control valve according to a tenth embodiment.

FIG. 25 is a plan view of a fluid control valve according to an eleventh embodiment.

FIG. 26 is a cross-sectional view taken along line XXVI-XXVI of FIG. 25.

### DETAILED DESCRIPTION

Hereinafter, examples of the present disclosure will be described.

According to an example of the present disclosure, a fluid control valve controls a flow of a fluid by switching communication and interruption between a plurality of ports provided in a housing. The fluid control valve is configured such that a valve is rotatably disposed inside a bottomed cylindrical housing including a plurality of ports with a seal member interposed therebetween. The seal member is provided at a portion where the plurality of ports are formed, and is physically crushed in the thickness direction (i.e., the radial direction of the valve) by the housing and the valve to adhere to both, thereby preventing fluid leakage between the plurality of flow paths in the housing. As an example, a torque is input to a valve from an actuator that rotates the valve is 3.5 N·m to 4.5 N·m.

In the fluid control valve, to prevent fluid leakage between the plurality of flow paths in the housing, it would be necessary to press the valve against the seal member to sufficiently ensure a crushing margin of the seal member. However, as the crushing margin of the seal member increases, the reaction force from the seal member to the valve increases, thereby increasing the sliding resistance during the rotation of the valve and the torque required for rotating the valve (specifically, 3.5 N·m to 4.5 N·m). Therefore, a large output motor, a speed reduction mechanism with a high reduction ratio, or the like is required as an actuator for driving the valve, which, in addition to increasing the size of the actuator, causes an increase in operation sound, power consumption, and electrical noise during the rotation of the valve.

In the fluid control valve, when the valve starts to rotate from the stopped state, a large torque is required because a part of the valve is stuck in the seal member at the end portion in the circumferential direction or the like of the seal member, or a part of the valve stuck in the seal member is pulled out from the seal member. As a result, large and small torques are input to the actuator in waves, causing large stress fluctuations on the gears constituting the speed reduction mechanism, which accelerates the breakage and wear of the gears.

Furthermore, in the fluid control valve, when wear occurs on the sliding surface between the valve and the seal member due to aging degradation or the like, sealability between the valve and the seal member may decrease, and the amount of fluid leakage between the plurality of flow paths in the housing may increase.

According to an example of the present disclosure, a fluid control valve includes: a valve having a side wall along a side surface in a conical shape and a flow path recessed from the side wall toward an axis of the side wall in the conical shape; a housing rotatably accommodating the valve about an axial center of rotation that is the axis of the conical shape, the housing having a port that passes through an outer wall and an inner wall; a seal member provided between the inner wall of the housing and the valve, the seal member having a surface on a housing side and in contact with a port periphery of the inner wall of the housing and a surface on the valve side in sliding contact with a side wall of the valve; and a biasing member biasing the valve toward an apex of the conical shape of the valve. The biasing member is configured to, during both rotation and stop of the valve, keep the side wall of the valve and the seal member in sliding contact with each other, and keep the inner wall of the housing and the seal member in contact with each other.

According to this, the fluid control valve is configured such that the side wall of the valve is shaped along the side surface of the conical shape, and the valve is biased toward the apex of the conical shape by the biasing member. Thus, by adjusting the biasing force of the biasing member, it is possible to facilitate the adjustment of the pressing force between the valve and the seal member and the pressing force between the housing and the seal member can be easily adjusted Therefore, the gap between the valve and the seal member and the gap between the housing and the seal member can be made as small as possible or eliminated to ensure sealability with a minute amount of fluid leakage between the flow paths. Therefore, since the valve is prevented or reduced from gouging the seal member, torque during the rotational drive of the valve can be reduced, and the torque can be prevented from being wavy. As a result, the fluid control valve can reduce the size of the actuator that drives the valve, as well as reduce the operation sound, power consumption, and electrical noise at the time of rotation of the valve, while ensuring sealability at the time of rotation and stop of the valve. Further, the breakage of the gear of the actuator can be prevented, and reliability can be improved.

Moreover, with the configuration in which the side wall of the valve is shaped along the side surface of the conical shape and the valve is biased toward the apex of the conical shape by the biasing member, even if wear occurs on the sliding surface between the valve and the seal member due to aging degradation or the like, the valve and the seal member are kept in sliding contact with each other. Therefore, the fluid control valve can maintain sealability between the valve and the seal member against aging degradation.

Hereinafter, embodiments of the present disclosure will be described with reference to the drawings. In the following embodiments, the same or equivalent portions are denoted by the same reference numerals, and the description thereof will be omitted.

### First Embodiment

A first embodiment will be described with reference to the drawings. The fluid control valve of the present embodiment controls the flows of fluids with different properties that flow through a plurality of fluid passages (not illustrated). The fluid with different properties is, for example, cooling water at different temperatures.

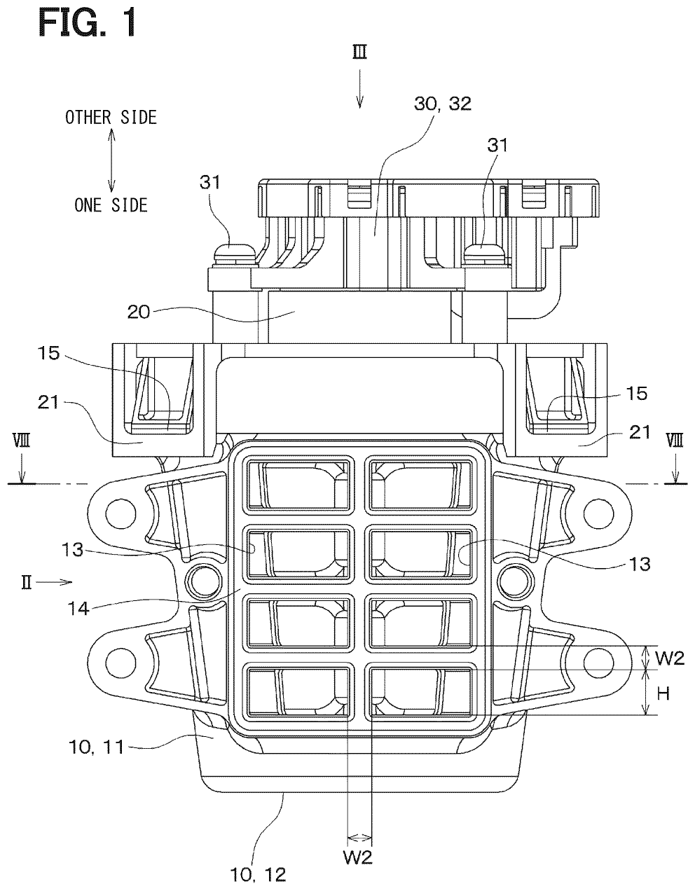

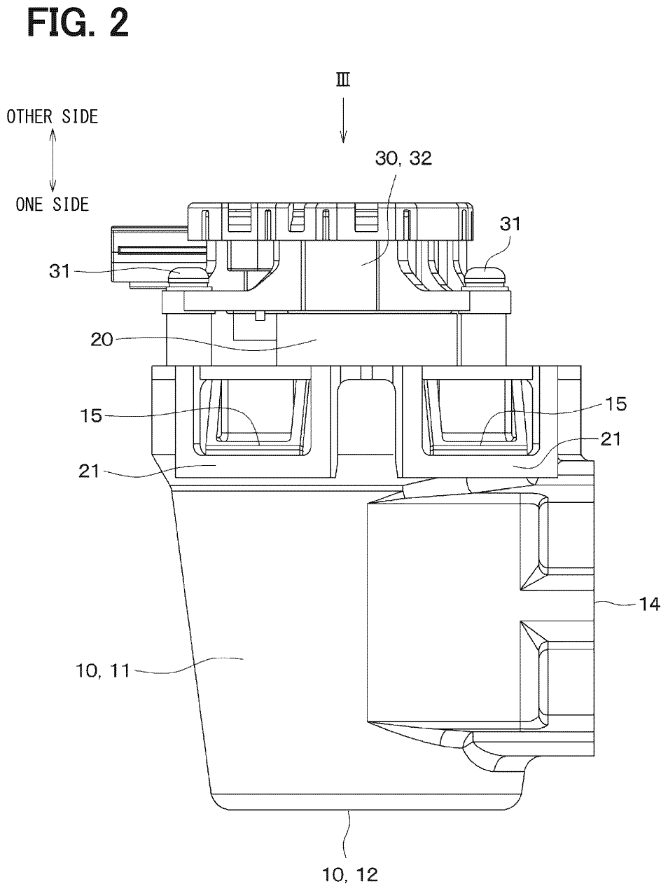

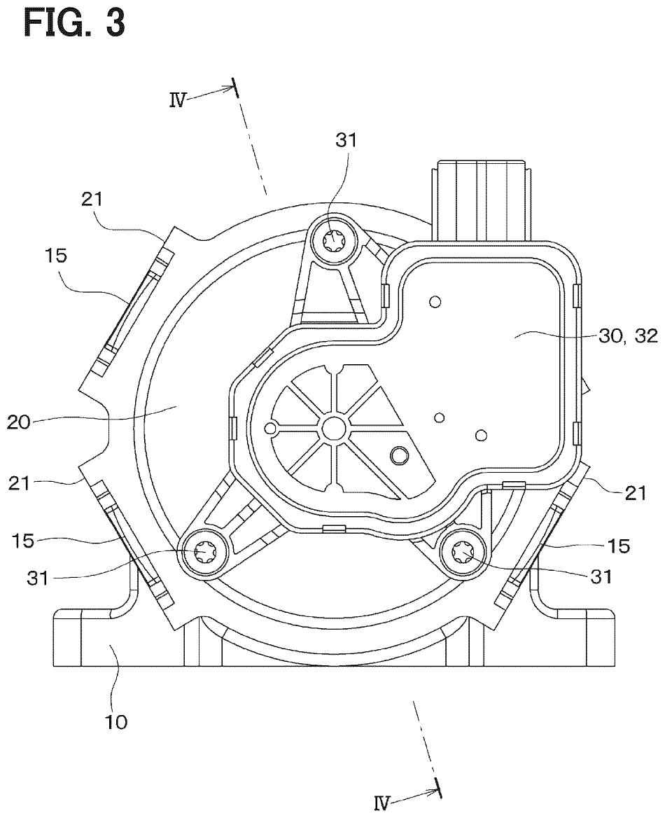

As illustrated in FIGS. 1 to 4, the fluid control valve includes a housing 10, a cover 20, an actuator 30, a valve 40, a seal member 50, a spring 60 serving as a biasing member, and the like.

The housing 10 includes a cylinder 11 formed in a cylindrical shape and a bottom 12 that closes one side of the cylinder 11. The housing 10 includes a plurality of ports 13 in a part of the cylinder 11. The port 13 penetrates an inner wall 16 and an outer wall 14 of the cylinder 11. A distance H of each port 13 parallel to a direction in which an axial center CL of the cylinder 11 extends is, for example, 10 mm. Hereinafter, the direction in which the axial center CL extends is referred to as an “axial direction”.

The housing 10 is formed of, for example, at least one of a reinforcement of polyamide 66 (hereinafter referred to as “PA66”), a reinforcement of polyphthalamide (hereinafter referred to as “PPA”), and a reinforcement of polyphenylene sulfide (hereinafter referred to as “PPS”). The reinforcement is, for example, glass fiber. Hereinafter, the bottom 12 side in the axial direction of the cylinder 11 will be described as one side, and the side opposite to the bottom 12 in the axial direction of the cylinder 11 will be described as the other side.

The cover 20 closes an opening on the other side of the cylinder 11 of the housing 10. The cover 20 is fixed to a locking portion 15 provided on the outer wall 14 of the cylinder 11 by a snap-fit 21. An actuator 30 is fixed to the other side of the cover 20 by a screw 31. The actuator 30 includes an electric motor, a speed reduction mechanism, and the like (not illustrated) inside a case 32.

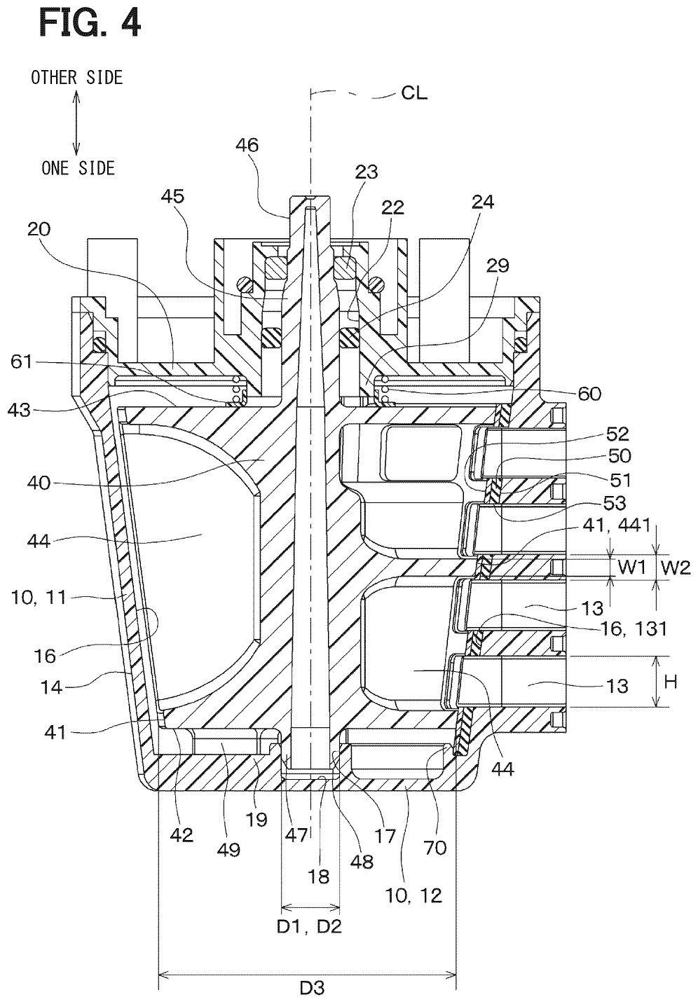

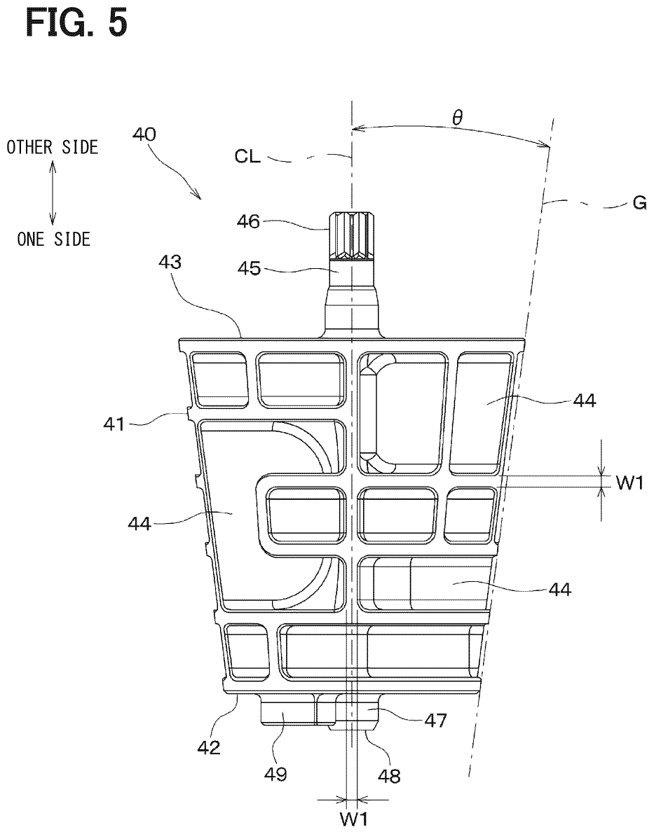

As illustrated in FIG. 4, the valve 40 is rotatably provided inside the housing 10 about a predetermined axial center CL. Here, a conical shape having the same axis as the axial center CL of rotation of the valve 40 is defined. In FIG. 5, only a part of the axis of the conical shape and a part of a generatrix G are indicated by dash-dot lines. The axis of the conical shape coincides with the axial center CL of the valve 40. As the definition of the conical shape, a surface obtained by rotating the generatrix G around the axis is referred to as a side surface, a contact point between the generatrix G and the axis is referred to as an apex, and a surface facing the apex and perpendicular to the axis is referred to as a bottom surface. As illustrated in FIGS. 4 and 5, the valve 40 includes a side wall 41 formed along the side surface of the conical shape. The valve 40 has a one-side end surface 42 formed on the apex side (i.e., one side) of the conical shape and an other-side end surface 43 facing the one-side end surface 42 and formed on the bottom surface side (i.e., the other side) of the conical shape. An internal angle θ formed by the generatrix G of the conical shape, along which the side wall 41 of the valve 40 extends, and the axial center CL of the valve 40 is set to 5 deg or more. The one-side end surface 42 and the other-side end surface 43 are formed perpendicular to the axial center CL of the valve 40.

The valve 40 is disposed such that the one-side end surface 42 faces the bottom 12 of the housing 10, and is rotatably accommodated inside the housing 10 with the axis of the conical shape as the axial center CL of rotation. The inner wall 16 of the cylinder 11 of the housing 10 is shaped along a side surface of a conical shape similar to and coaxial with the conical shape along which the side wall 41 of the valve 40 extends. That is, the inner wall 16 of the cylinder 11 of the housing 10 and the side wall 41 of the valve 40 are formed in parallel.

The valve 40 includes a plurality of flow paths 44 recessed from the side wall 41 toward the axial center CL. The valve 40 changes the rotational phase, and the plurality of flow paths 44 of the valve 40 respectively communicate with the plurality of ports 13 of the housing 10, thereby switching communication and interruption between the plurality of ports 13.

The valve 40 includes an input shaft 45 that protrudes to the other side in the axial direction from the position of the other-side end surface 43, which is centered on the axial center CL. The input shaft 45 is inserted through an insertion hole 22 provided in the cover 20. A bearing 23 and a shaft seal member 24 are provided between the inner wall of the insertion hole 22 and the input shaft 45. The bearing 23 is, for example, a ball bearing, a rolling bearing, or the like, and rotatably supports the input shaft 45 with respect to the cover 20. The shaft seal member 24 is, for example, an O-ring, an oil seal, or the like, and prevents fluid leakage from the gap between the inner wall of the insertion hole 22 and the input shaft 45. A gear 46 is provided at the distal end of the input shaft 45 protruding from the cover 20, and torque for rotating the valve 40 is input from the actuator 30. The torque input from the actuator 30 to the input shaft 45 for rotating the valve 40 with respect to the housing 10 and the seal member 50 is set to 2.0 N·m or less.

Furthermore, the valve 40 includes a protrusion 47 protruding from the position of the one-side end surface 42, which is centered on the axial center CL, to one side in the axial direction, and a stopper 49 protruding from the position of the one-side end surface 42 away from the axial center CL to one side in the axial direction.

The protrusion 47 of the valve 40 is inserted into a hole 17 provided in the bottom 12 of the housing 10 and rotatably supported by the inner wall of the hole 17. When D1 is the outer diameter of the protrusion 47 of the valve 40, that D2 is the inner diameter of the hole 17 of the housing 10, and that D3 is the outer diameter of the one-side end surface 42 of the valve 40, the relationships of D1<D3 and D2<D3 hold. Since D1 is slightly smaller than D2, the relationship of D1<D2<D3 holds. Thus, by reducing the radius of the sliding portion on which the protrusion 47 of the valve 40 and the hole 17 of the housing 10 slide, that is, D1 and D2, the sliding resistance of the sliding portion can be reduced, and torque during the rotational drive of the valve 40 can be reduced. The inner wall of the hole 17 is formed in parallel with the axial center CL and allows the movement of the protrusion 47 of the valve 40 in the axial direction. A distal end surface 48 on one side in the axial direction of the protrusion 47 of the valve 40 and a bottom surface 18 on one side in the axial direction of the hole 17 of the housing 10 have no contact with each other.

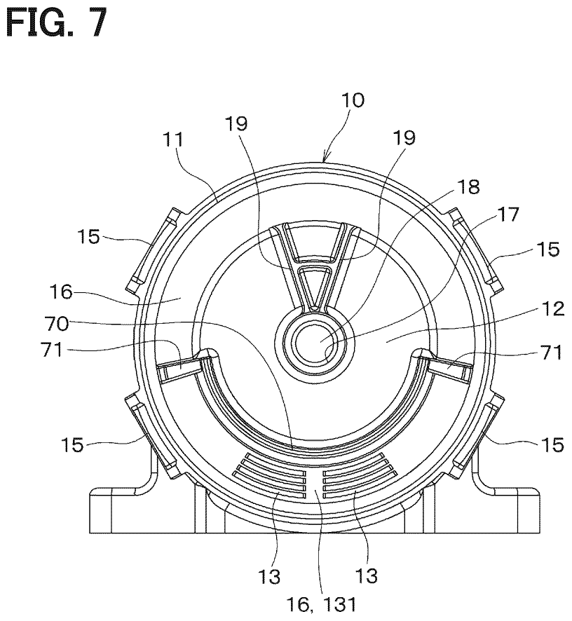

As illustrated in FIGS. 4 and 7, the bottom 12 of the housing 10 is provided with a stopper contact portion 19 that can be contacted by the stopper 49 of the valve 40. The contact between the stopper 49 of the valve 40 and the stopper contact portion 19 of the housing 10 defines the default position of the valve 40 in rotation.

The valve 40 is formed of, for example, at least one of a reinforcement of PA66, a reinforcement of PPA, a reinforcement of PPS, and a reinforcement of phenol (hereinafter referred to as “PF”).

As illustrated in FIG. 4, the seal member 50 is provided between the inner wall 16 of the housing 10 and the valve 40. The seal member 50 is formed in a plate shape, a surface 51 on the housing 10 side is in contact with a portion of the inner wall 16 of the housing 10 on the periphery of the port 13, and a surface 52 on the valve 40 side is in sliding contact with a portion of the side wall 41 of the valve 40, which is in sliding contact with the seal member 50. In the following description, the portion of the inner wall 16 of the housing 10 on the periphery of the port 13 is referred to as a “port periphery 131”, and the portion of the side wall 41 of the valve 40 in sliding contact with the seal member 50 is referred to as a “flow path periphery 441”. The seal member 50 includes a plurality of openings 53 penetrating in the plate thickness direction. The plurality of openings 53 of the seal member 50 are provided at positions corresponding to the plurality of ports 13 of the housing 10.

Here, the width of the flow path periphery 441 of the outer wall 14 of the valve 40 is W1, and the width of the port periphery 131 of the inner wall 16 of the housing 10 is W2. At this time, the relationship of W1≤W2 holds. This can reduce the pressure loss of the fluid flowing into the flow path 44 of the valve 40 from the port 13 of the housing 10. The width of the portion forming the opening 53 in the seal member 50 is set to be substantially the same as the width W2 of the port periphery 131 of the housing 10.

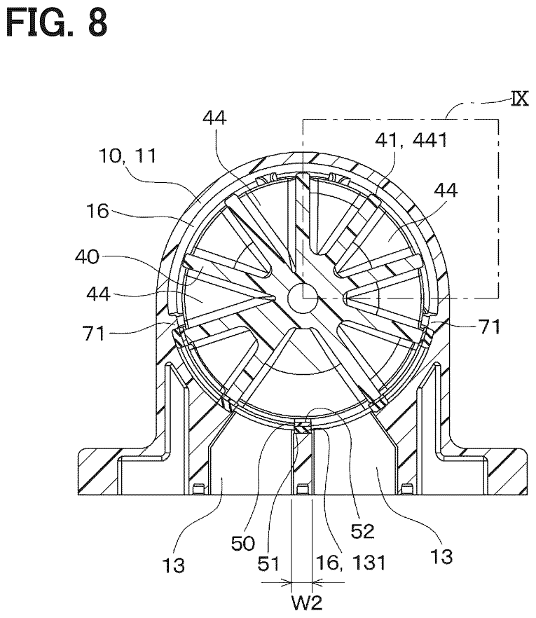

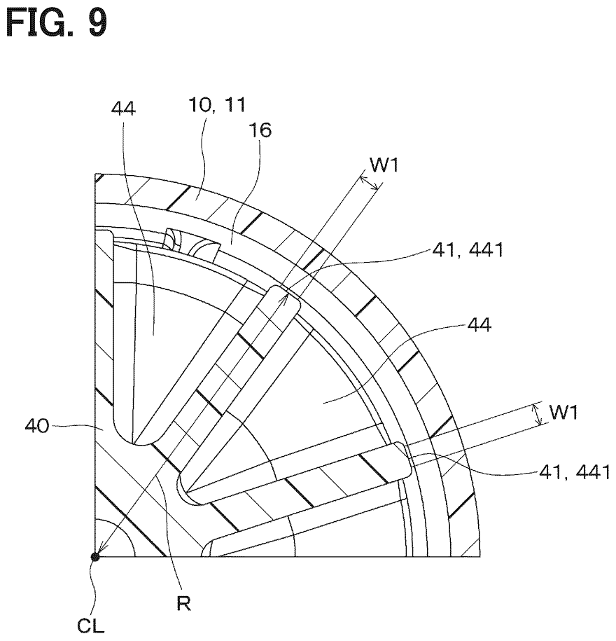

The width W1 of the flow path periphery 441 and the width W2 of the port periphery 131 are both 2 mm or more. As illustrated in FIGS. 8 and 9, a radius of curvature R of the flow path periphery 441 of the valve 40 is the same as or larger than the radius of curvature of the surface 52 on the valve 40 side of the seal member 50 at the same position in the axial direction. The term “the same” includes substantially the same. In other words, the flow path periphery 441 of the valve 40 is preferably a curved surface or a flat surface having the radius of curvature that is the same as or larger than that of the conical shape along which the outer wall 14 of the valve 40 extends, and the tip of the curved portion with a radius R, protruding outward in the radial direction, is relatively not preferable. Thus, surface contact between the flow path periphery 441 of the valve 40 and the seal member 50 is achieved. Therefore, the gap between the valve 40 and the seal member 50 and the gap between the housing 10 and the seal member 50 can be made as small as possible or eliminated to ensure sealability with a minute amount of fluid leakage between the flow paths 44. The method of preventing fluid leakage using a minute gap with a relatively long distance (e.g., about 2 mm or more), as described above, may be referred to as a “gap seal”.

In the seal member 50, a material of a portion on the housing 10 side differs from a material of a portion on the valve 40 side. Specifically, the material of the seal member 50 is at least one of a combination of rubber and polytetrafluoroethylene (hereinafter referred to as “PTFE”), a combination of rubber and a fluororesin, and a combination of rubber and a high-lubricity material. More specifically, the material of the seal member 50 is a rubber material on the housing 10 side, and PTFE, a fluororesin, or a high-lubricity material on the valve 40 side. Methods of manufacturing the seal member 50 include, for example, applying PTFE or the like to the surface of the rubber material, integrally assembling the rubber material and PTFE or the like, insert molding, adhesion, and baking.

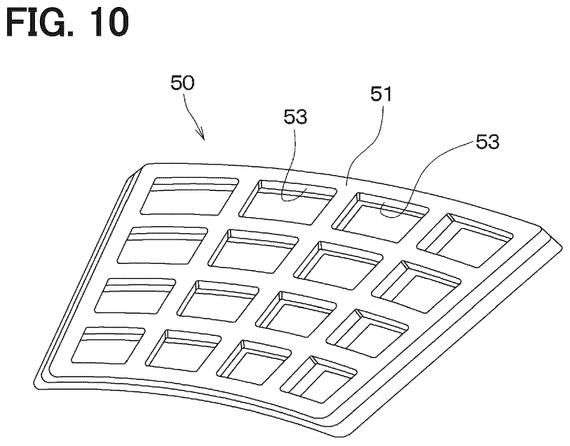

As illustrated in FIG. 10, the seal member 50 has a planar shape before being assembled to the housing 10 or in a state of being removed from the housing 10, or has a shape closer to a plane than in a state of being assembled to the housing 10. That is, the seal member 50 is a planar member in the state before assembly to the housing 10.

As illustrated in FIGS. 4 and 7, a housing-side regulating portion 70 and a circumferential regulating portion 71 that regulate the movement of the seal member 50 are provided inside the housing 10. The housing-side regulating portion 70 protrudes from the bottom 12 of the housing 10 to the other side in the axial direction. As illustrated in FIG. 7, the housing-side regulating portion 70 has a curved shape parallel to the inner wall 16 of the portion of the cylinder 11 of the housing 10 on the bottom 12 side when viewed from the other side in the axial direction. A portion of the seal member 50 disposed on the bottom 12 side is fitted between the housing-side regulating portion 70 and the inner wall 16 of the cylinder 11 of the housing 10. The housing-side regulating portion 70 regulates the movement of the seal member 50 inward in the radial direction and toward one side in the axial direction of the cylinder 11. The housing-side regulating portion 70 regulates the deformation of the seal member 50 from a curved surface shape along the inner wall 16 of the cylinder 11 of the housing 10 or the side wall 41 of the valve 40.

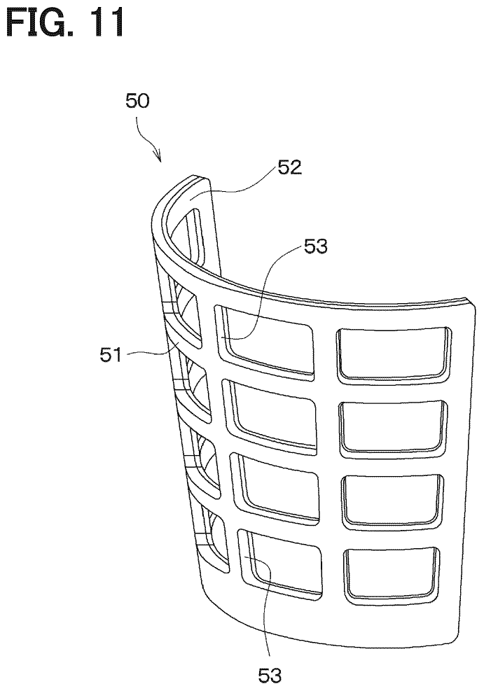

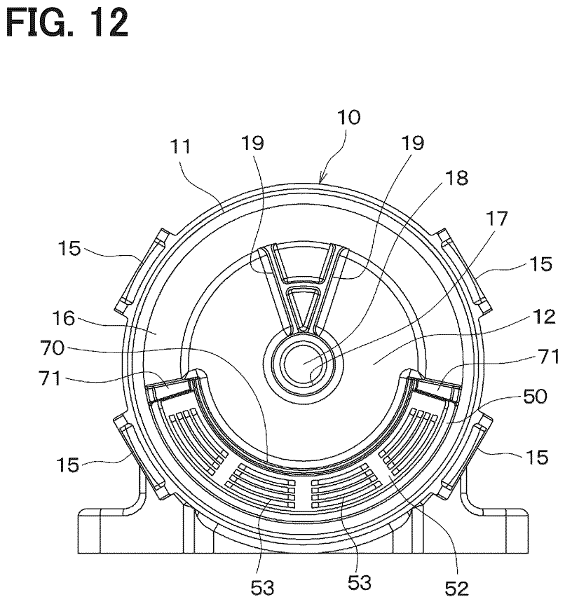

The circumferential regulating portion 71 protrudes inward in the radial direction from the inner wall 16 of the cylinder 11 of the housing 10. The height of the circumferential regulating portion 71 protruding inward in the radial direction from the inner wall 16 of the cylinder 11 of the housing 10 is smaller than the thickness of the seal member 50. The circumferential regulating portion 71 is provided on each of one side and the other side in the circumferential direction of the seal member 50 disposed inside the housing 10, and regulates the movement of the seal member 50 to one side and the other side in the circumferential direction of the cylinder 11. Thus, as illustrated in FIGS. 11 and 12, the seal member 50, in an assembled state to the housing 10, is maintained in a curved surface shape along the inner wall 16 of the cylinder 11 of the housing 10, regulating movement in the axial direction and the circumferential direction.

As illustrated in FIG. 4, the spring 60 serving as a biasing member is provided between the other-side end surface 43 of the valve 40 and the cover 20. The spring 60 is a compression coil spring, and biases the valve 40 toward the apex of the conical shape. As described above, the internal angle θ formed by the generatrix G of the conical shape, along which the side wall 41 of the valve 40 extends, and the axial center CL of the valve 40 is set to 5 deg or more. Thereby, a component force acting on the seal member 50 and the housing 10 from the side wall 41 of the valve 40 are generated in response to the load applied by the spring 60 in the axial direction of the valve 40. Thus, a part of the biasing force of the spring 60 acts as a component force for pressing the valve 40 and the seal member 50, and further acts as a component force for pressing the seal member 50 and the inner wall 16 of the housing 10. Therefore, by adjusting the spring force of the spring 60, it is possible to keep a state in which the side wall 41 of the valve 40 and the seal member 50 are in sliding contact with each other with small sliding resistance and to keep a state in which the inner wall 16 of the housing 10 and the seal member 50 are in contact with each other during both the rotation and stop of the valve 40. In other words, the spring force of the spring 60 is adjusted to bring the side wall 41 of the valve 40 and the seal member 50 into sliding contact with each other with small sliding resistance, and the inner wall 16 of the housing 10 and the seal member 50 into contact with each other. Furthermore, the spring force of the spring 60 is adjusted to prevent or reduce gouging of the seal member 50 by the flow path periphery 441 of the valve 40. As a result, the gap seal described above can be achieved between the valve 40 and the seal member 50 and between the housing 10 and the seal member 50, and torque during the rotational drive of the valve 40 can be reduced. In addition, since the axial length of the spring 60 is kept constant during the rotation of the valve 40, the biasing force of the spring 60 is also kept constant. Therefore, torque fluctuation during the rotational drive of the valve 40 can be reduced.

A spring guide 61 is provided between the other-side end surface 43 of the valve 40 and the spring 60. The spring guide 61 supports the end portion of the spring 60 on the valve 40 side. The spring guide 61 has an L-shaped cross-section parallel to the axial center CL, and includes an inner surface in the radial direction in sliding contact with the protruding portion 29 forming the insertion hole 22 of the cover 20 and a surface on one side in the axial direction in sliding contact with the other-side end surface 43 of the valve 40. The spring guide 61 can prevent the axial displacement of the spring 60 and transmit the biasing force of the spring 60 to the valve 40.

The material of the spring guide 61 differs from the material of the valve 40. Specifically, the material of the spring guide 61 is at least one of metal only, a material with PTFE applied to a metal surface, a material with a fluororesin applied to a metal surface, a material with a high-lubricity material applied to a metal surface, resin only, a material with PTFE applied to a resin surface, a material with a fluororesin applied to a resin surface, and a material with a high-lubricity material applied to a resin surface.

In each configuration of the fluid control valve described above, the valve 40, the seal member 50, and the cover 20 are configured to be removable from the housing 10 from the other side in the axial direction. Therefore, the following steps can be employed as a method for manufacturing the fluid control valve. First, the planar seal member 50 in a component state is deformed with respect to the housing 10 and assembled to the housing-side regulating portion 70 and the circumferential regulating portion 71. Next, the valve 40 is assembled to the housing 10 from the other side in the axial direction. At this time, the protrusion 47 of the valve 40 is inserted into the hole 17 of the housing 10. Subsequently, the spring 60 and the spring guide 61 are arranged, and the cover 20 is assembled to the housing 10 in a state where the axial center CL is aligned so that the gear 46 of the input shaft 45 of the valve 40 and the shaft seal member 24 of the cover 20 do not come into contact with each other. Finally, the actuator 30 is assembled to the cover 20 by the screw 31, and the assembly of the fluid control valve is completed.

The fluid control valve of the first embodiment described above exerts the following effects.

(1) In the first embodiment, the side wall 41 of the valve 40 is shaped along the side surface of the conical shape, and the valve 40 is biased toward the apex of the conical shape by the spring 60. Thus, by adjusting the spring force of the spring 60, it is possible to facilitate the adjustment of the pressing force between the valve 40 and the seal member 50 and the pressing force between the housing 10 and the seal member 50. Therefore, the gap between the valve 40 and the seal member 50 and the gap between the housing 10 and the seal member 50 can be made as small as possible or eliminated to ensure sealability with a minute amount of fluid leakage between the flow paths 44. Accordingly, since gouging of the seal member 50 by the valve 40 is prevented or reduced as in the configuration of the fluid control valve as described above, torque during the rotational drive of the valve 40 can be reduced, and the torque can be prevented from being wavy. As a result, the fluid control valve of the first embodiment can reduce the size of the actuator 30 that drives the valve 40, as well as reduce the operation sound, power consumption, and electrical noise during the rotation of the valve 40, while ensuring sealability during both the rotation and stop of the valve 40. Further, the breakage of the gear of the actuator 30 can be prevented, and reliability can be improved.

Furthermore, the fluid control valve of the first embodiment is configured such that the side wall 41 of the valve 40 is shaped along the side surface of the conical shape, and the valve 40 is biased by the spring 60. Thus, even if wear occurs on the sliding surface between the valve 40 and the seal member 50 due to aging degradation or the like, the valve 40 and the seal member 50 are kept in sliding contact with each other. Therefore, the fluid control valve can maintain sealability between the valve 40 and the seal member 50 against aging degradation.

(2) In the first embodiment, a material of a portion of the seal member 50 on the housing 10 side differs from a material of a portion on the valve 40 side.

According to this, as the material of the seal member 50, a material suitable for coming into contact with the housing 10 and sliding contact with the valve 40 can be selected.

(3) Specifically, the material of the seal member 50 is a rubber material on the housing 10 side, and PTFE, a fluororesin, or a high-lubricity material on the valve 40 side.

According to this, at least one of a rubber material, silicone, PTFE, a fluororesin, and a resin material with elasticity is employed as the material of the seal member 50. Thus, the seal member 50 can be deformed to conform to the shape of the inner wall 16 of the housing 10 by the spring force of the spring 60. Therefore, the ease of assembly of the seal member 50 is improved, and the gap between the valve 40 and the seal member 50 and the gap between the housing 10 and the seal member 50 can be made as small as possible or eliminated to ensure sealability with a minute amount of fluid leakage between the flow paths 44.

Furthermore, by using at least one of PTFE, a fluororesin, and a high-lubricity material as the material of the seal member 50 on the valve 40 side, it is possible to ensure sealability with a minute amount of fluid leakage between the flow paths 44 and to reduce the sliding resistance between the valve 40 and the seal member 50.

(4) In the first embodiment, the fluid control valve includes the spring guide 61 provided between the valve 40 and the spring 60.

This prevents the edge of the spring 60 from being caught on the surface of the valve 40 and prevents the sliding resistance between the spring 60 and the valve 40 from increasing due to the edge of the spring 60 scratching the surface of the valve 40. Therefore, torque during the rotational drive of the valve 40 can be reduced.

(5) In the first embodiment, the material of the spring guide 61 differs from the material of the valve 40.

According to this, it is possible to select a material capable of reducing the sliding resistance between the spring guide 61 and the valve 40.

(6) In the first embodiment, the material of the spring guide 61 is at least one of a material with PTFE applied to a metal surface, a material with a fluororesin applied to a metal surface, a material with a high-lubricity material applied to a metal surface, a material with PTFE applied to a resin surface, a material with a fluororesin applied to a resin surface, and a material with a high-lubricity material applied to a resin surface.

According to this, the sliding resistance between the spring guide 61 and the valve 40 can be reduced.

The material of the spring guide 61 is not limited to those exemplified above and may be only metal or only resin.

(7) In the first embodiment, the valve 40 includes the protrusion 47 that protrudes in the axial direction from the position of the one-side end surface 42, which is centered on the axial center CL. The housing 10 includes the hole 17 that rotatably supports the protrusion 47 of the valve 40.

According to this, the hole 17 of the housing 10 rotatably supports the protrusion 47 of the valve 40, thereby preventing the positional displacement of the axial center CL of the valve 40. Therefore, the pressed state between the valve 40 and the seal can be stabilized, the side wall 41 of the valve 40 and the seal member 50 can be kept in sliding contact with each other with small sliding resistance, and sealability during both the rotation and stop of the valve 40 can be ensured.

(8) In the first embodiment, the outer diameter D1 of the protrusion 47 of the valve 40 and the inner diameter D2 of the hole 17 of the housing 10 are smaller than the outer diameter D3 of the one-side end surface 42 of the valve 40.

According to this, by reducing the radius of the sliding portion between the protrusion 47 of the valve 40 and the hole 17 of the housing 10, the sliding resistance of the sliding portion can be reduced, and torque during the rotational drive of the valve 40 can be reduced.

(9) In the first embodiment, the distal end surface 48 on one side in the axial direction of the protrusion 47 of the valve 40 and the bottom surface 18 on one side in the axial direction of the hole 17 of the housing 10 have no contact with each other.

According to this, it is possible to eliminate sliding at the locations of the sliding of the hole 17 of the housing 10 and the protrusion 47 of the valve 40, which are not related to the function of preventing the positional displacement of the axial center CL of the valve 40, and to reduce torque during the rotational drive of the valve 40.

(10) In the first embodiment, both the width W1 of the flow path periphery 441 of the side wall 41 of the valve 40 and the width W2 of the port periphery 131 of the housing 10 are 2 mm or more.

According to this, in the configuration in which the port periphery 131 of the housing 10 and the seal member 50 are brought into surface contact with each other, by increasing the width W2 of the port periphery 131 and increasing the width of surface contact, it is possible to reduce the amount of fluid leakage between the ports 13 to an even more minute level and improve sealability.

Similarly, in the configuration in which the flow path periphery 441 of the valve 40 and the seal member 50 are brought into surface contact with each other, by increasing the width W1 of the flow path periphery 441 and increasing the width of surface contact, it is possible to reduce the amount of fluid leakage between the flow paths 44 to an even more minute level and improve sealability.

In addition, by increasing the width of the surface contact between the flow path periphery 441 of the valve 40 and the seal member 50, the gouging of the seal member 50 by the flow path periphery 441 of the valve 40 is prevented or reduced. Therefore, torque during the rotational drive of the valve 40 can be reduced, and the torque can be prevented from being wavy. Therefore, stress on the actuator 30 that drives the valve 40 can be reduced.

(11) In the first embodiment, the width W1 of the flow path periphery 441 of the side wall 41 of the valve 40 and the width W2 of the port periphery 131 of the housing 10 have the relationship of W2≥W1.

According to this, by making the width W1 of the flow path periphery 441 of the valve 40 equal to or smaller than the width W2 of the port periphery 131 of the housing 10, the pressure loss of the fluid flowing into the flow path 44 of the valve 40 from the port 13 of the housing 10 can be reduced.

(12) In the first embodiment, the radius of curvature R of the flow path periphery 441 of the valve 40 is the same as or larger than the radius of curvature of the surface 52 on the valve 40 side of the seal member 50 at the same position in the axial direction.

According to this, in the configuration in which the gap between the flow path periphery 441 of the valve 40 and the seal member 50 can be made as small as possible or eliminated to ensure sealability, the surface contact between the flow path periphery 441 of the valve 40 and the seal member 50 is achieved. Therefore, it is possible to reduce the amount of fluid leakage between the flow paths 44 to an even more minute level in the housing 10 and improve sealability.

In addition, by increasing the radius of curvature R of the flow path periphery 441, the gouging of the seal member 50 by the flow path periphery 441 of the valve 40 can be prevented or reduced. Therefore, torque during the rotational drive of the valve 40 can be reduced, and the torque can be prevented from being wavy. Therefore, stress on the actuator 30 that drives the valve 40 can be reduced.

(13) In the first embodiment, the torque required for rotating the valve 40 with respect to the housing 10 and the seal member 50 is 2.0 N·m or less.

According to this, the size of the actuator 30 that drives the valve 40 can be reduced, achieving a reduction in operation sound, power consumption, and electrical noise during the rotation of the valve 40.

(14) In the first embodiment, the internal angle θ formed by the generatrix G of the conical shape, along which the side wall 41 of the valve 40 extends, and the axial center CL of the valve 40 is 5 deg or more.

According to this, it is possible to obtain a desired component force capable of keeping the sliding contact state between the side wall 41 of the valve 40 and the seal member 50 and the contact state between the inner wall 16 of the housing 10 and the seal member 50 in response to the load applied by the spring 60 in the axial direction of the valve 40. Therefore, the gap between the valve 40 and the seal member 50 and the gap between the housing 10 and the seal member 50 can be made as small as possible or eliminated to ensure sealability with a minute amount of fluid leakage between the flow paths 44. In contrast, if the internal angle θ formed by the generatrix G of the conical shape, along which the side wall 41 of the valve 40 extends, and the axial center CL of the valve 40 is less than 5 deg, a desired component force cannot be obtained, making is difficult to ensure sealability.

The upper limit of the internal angle θ formed by the generatrix G of the conical shape, along which the side wall 41 of the valve 40 extends, and the axial center CL of the valve 40 is appropriately set according to the volume in the flow path 44 of the valve 40, the radial size of the housing 10, and the like.

(15) In the first embodiment, the inner wall 16 of the cylinder 11 of the housing 10 has a shape along a side surface of a conical shape similar to and coaxial with the conical shape along which the side wall 41 of the valve 40 extends.

According to this, a component force acting on the seal member 50 and the housing 10 from the side wall 41 of the valve 40 are generated in response to the load applied by the spring 60 in the axial direction of the valve 40. With this component force, the inner wall 16 of the housing 10 and the seal member 50 can be kept in a contact state, and sealability can be ensured.

(16) In the first embodiment, the material of the housing 10 is at least one of a reinforcement of PA66, a reinforcement of PPA, a reinforcement of PPS.

According to this, it is possible to achieve both the molding dimensional accuracy and the strength of the housing 10.

(17) In the first embodiment, the material of the valve 40 is at least one of a reinforcement of PA66, a reinforcement of PPA, a reinforcement of PPS, and a reinforcement of PF.

This makes it possible to reduce the sliding resistance between the side wall 41 of the valve 40 and the seal member 50 while ensuring the molding dimensional accuracy and the strength of the valve 40.

(18) In the first embodiment, the valve 40, the seal member 50, and the cover 20 are configured to be removable from the housing 10 from the other side in the axial direction.

According to this, contrary to the configuration of the first embodiment, if the input shaft 45 is provided on the one-side end surface 42 of the valve 40, the insertion hole 22, through which the input shaft 45 is inserted, and the shaft seal member 24 are provided in the bottom 12 of the housing 10. In this case, when the valve 40 is assembled to the housing 10 during the manufacturing of the fluid control valve, it is necessary to carefully assemble the valve so that the gear 46 of the input shaft 45 and the shaft seal member 24 do not come into contact with each other and the shaft seal member 24 is not damaged, which is difficult. Specifically, it is necessary to assemble the valve 40 to the housing 10 while keeping the axial center CL of the housing 10 and the axial center CL of the valve 40 aligned over the entire assembly stroke.

In contrast, in the first embodiment, the input shaft 45 is provided on the other-side end surface 43 of the valve 40, and the cover 20 includes the insertion hole 22 and the shaft seal member 24. Therefore, when the valve 40 is assembled to the housing 10 during the manufacturing of the fluid control valve, the risk of contact between the input shaft 45 and the shaft seal member 24 is reduced, thereby facilitating the assembly.

(19) In the first embodiment, the cover 20 is fixed to the housing 10 by the snap-fit 21.

According to this, the number of parts required for assembling and fixing the cover 20 to the housing 10 can be reduced.

(20) In the first embodiment, the valve 40 includes the stopper 49 on the one-side end surface 42. The housing 10 includes the stopper contact portion 19 that receives the stopper 49 of the valve 40.

According to this, by providing the stopper 49 on the one-side end surface 42 of the valve 40 and not on the side wall 41, the sealing surface can be reliably ensured.

(21) In the first embodiment, the stopper contact portion 19 is provided on the bottom 12 of the housing 10 and is not provided on the cover 20.

According to this, by providing the stopper contact portion 19 in the housing 10 and not on the cover 20, it is possible to reduce the load factor on the fastening portion between the housing 10 and the cover 20, for example, the snap-fit 21.

### Second to Seventh Embodiments

The second to seventh embodiments differ from the first embodiment in the configuration of the sliding portion between the one-side end surface 42 of the valve 40 and the bottom 12 of the housing 10, while the others are the same as those of the first embodiment, and thus only the part that differs from the first embodiment will be described.

### Second Embodiment

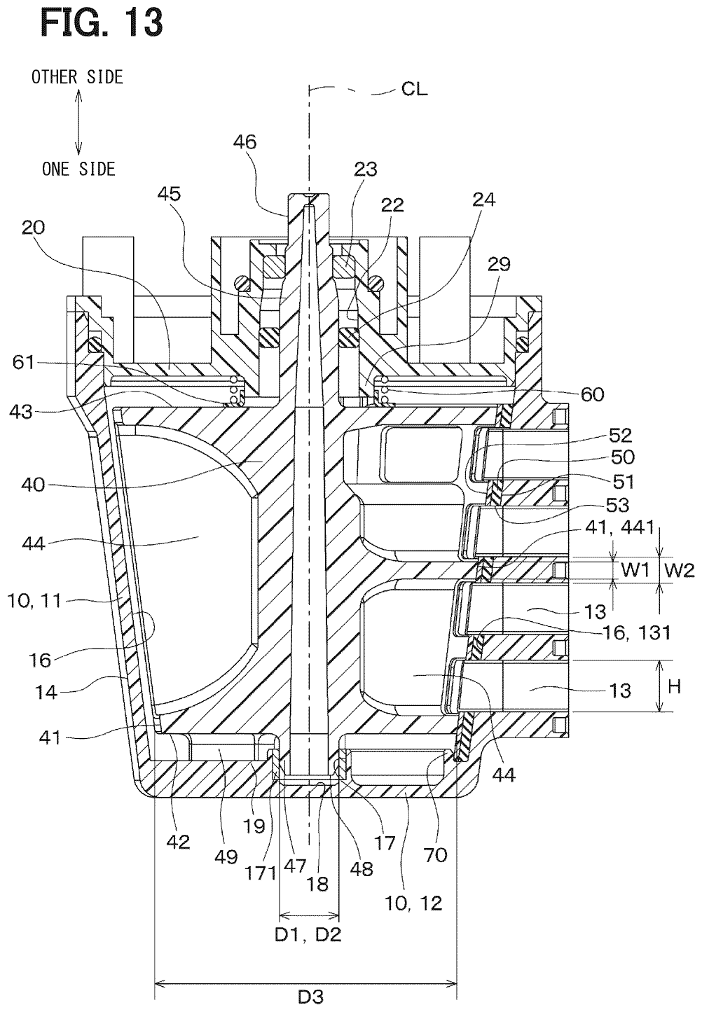

As illustrated in FIG. 13, the fluid control valve of the second embodiment includes a bearing 171 between the protrusion 47 protruding from the one-side end surface 42 of the valve 40 and the hole 17 provided in the bottom 12 of the housing 10. The bearing 171 is, for example, a sliding bearing, is fixed to the inside of the hole 17 of the housing 10, and slides on the protrusion 47 of the valve 40. The bearing 171 and the housing 10 are integrally molded by insert molding or two-color molding. Alternatively, the bearing 171 may be post-assembled to the inside of the hole 17 of the housing 10 by outsert molding, press-fitting, or the like.

As the material of the bearing 171, a material different from the material of the valve 40 or the housing 10, such as metal, may be used. Alternatively, when the same type of material as the material of the valve 40 or the housing 10 is used as the material of the bearing 171, at least one of PTFE, a fluororesin, and a high-lubricity material is blended. Alternatively, the bearing 171 may be a material with at least one of PTFE, a fluororesin, and a high-lubricity material applied to a metal surface or a resin surface.

The fluid control valve of the second embodiment described above exerts the following effects.

(1) The fluid control valve of the second embodiment includes the bearing 171 provided between the protrusion 47 of the valve 40 and the hole 17 of the housing 10.

According to this, the sliding resistance between the protrusion 47 of the valve 40 and the hole 17 of the housing 10 can be further reduced.

(2) In the second embodiment, the material of the valve 40 or the housing 10 differs from the material of the bearing 171.

According to this, as the material of the bearing 171, any material different from the valve 40 or the housing 10 can be selected.

(3) In the second embodiment, when the material of the bearing 171 is the same as the material of the valve 40 or the housing 10, at least one of PTFE, a fluororesin, and a high-lubricity material is blended.

According to this, the sliding resistance between the bearing 171 and the protrusion 47 of the valve 40 can be further reduced. The bearing 171 is specifically a sliding bearing.

(4) In the second embodiment, the bearing 171 may be a material with at least one of PTFE, a fluororesin, and a high-lubricity material applied to a metal surface or a resin surface.

This also makes it possible to further reduce the sliding resistance between the bearing 171 and the protrusion 47 of the valve 40. The bearing 171 is specifically a sliding bearing.

### Third Embodiment

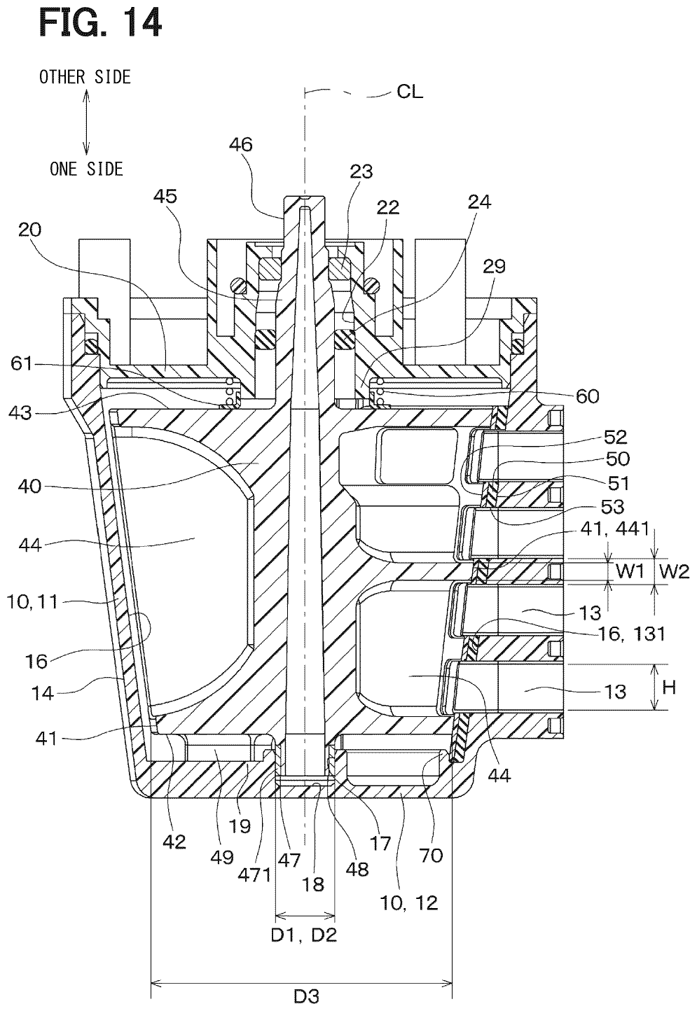

As illustrated in FIG. 14, the fluid control valve of the third embodiment also includes the bearing 471 between the protrusion 47 protruding from the one-side end surface 42 of the valve 40 and the hole 17 provided in the bottom 12 of the housing 10. The bearing 471 is, for example, a sliding bearing, is fixed to the outside of the protrusion 47 of the valve 40, and slides on the inner wall of the hole 17 of the housing 10. The bearing 471 and the valve 40 are integrally molded by insert molding or two-color molding. Alternatively, the bearing 471 may be post-assembled to the outside of the protrusion 47 of the valve 40 by outsert molding, press-fitting, or the like.

As the material of the bearing 471, the same material as that described in the second embodiment can be used.

The fluid control valve of the third embodiment described above can also exert the same effects as those of the second embodiment.

### Fourth Embodiment

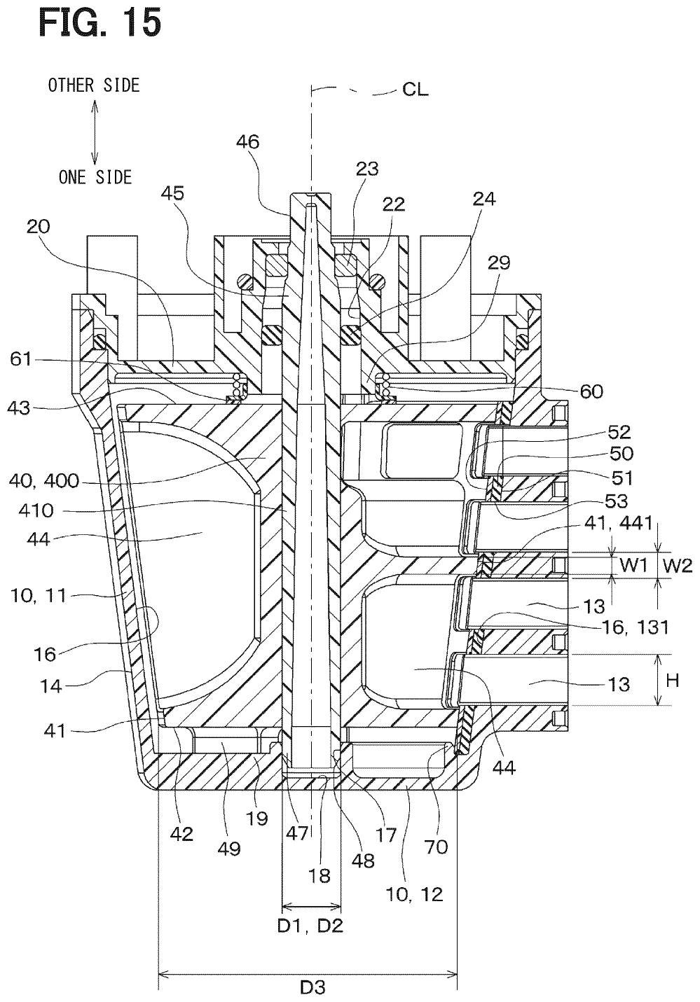

As illustrated in FIG. 15, the fluid control valve of the fourth embodiment includes the shaft 410 insert-molded in a valve body 400.

A portion of the shaft 410 protruding to one side from the one-side end surface 42 of the valve 40 constitutes the protrusion 47 of the valve 40. The protrusion 47 of the valve 40 is rotatably supported by the hole 17 of the housing 10. A portion of the shaft 410 protruding from the other-side end surface 43 of the valve 40 to the other side constitutes the input shaft 45.

The fluid control valve of the fourth embodiment described above exerts the following effects.

In the fourth embodiment, the protrusion 47 of the valve 40 is formed by the shaft 410 insert-molded in the valve body 400.

According to this, the dimensional accuracy of the protrusion 47 in the valve 40 can be improved, and the amount of positional displacement of the axial center CL of the valve 40 can be further reduced.

### Fifth Embodiment

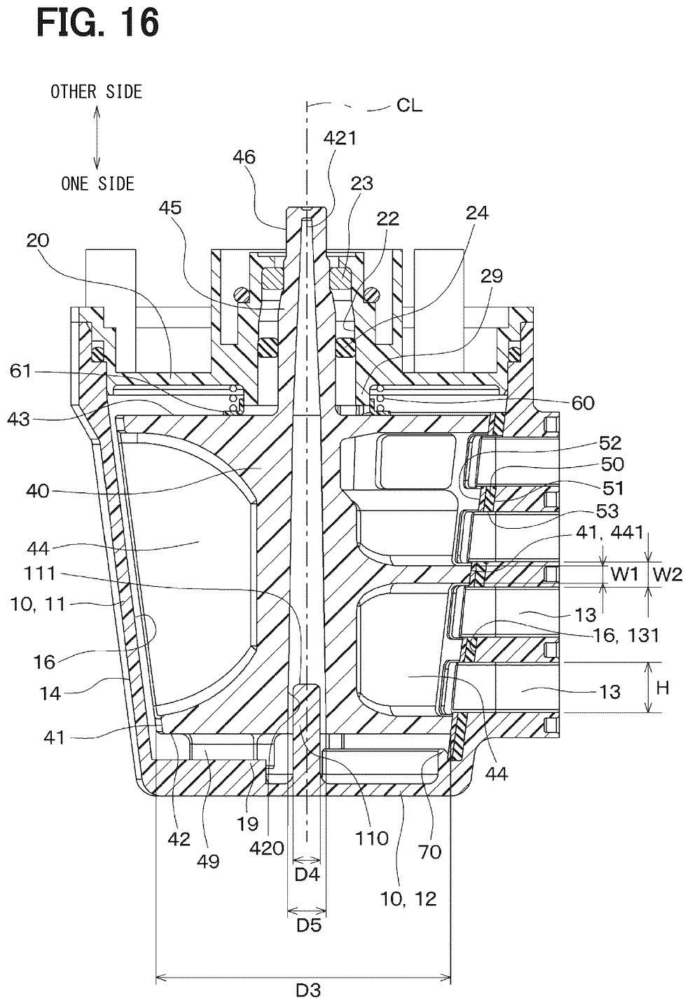

As illustrated in FIG. 16, the fluid control valve of the fifth embodiment does not include the protrusion 47 protruding from the one-side end surface 42 of the valve 40 and the hole 17 provided in the bottom 12 of the housing 10, as described in the first to fourth embodiments. Instead, the housing 10 of the fluid control valve of the fifth embodiment includes a protrusion-shaped portion 110 protruding to the other side in the axial direction at a position of the bottom 12, which is centered on the axial center CL. The valve 40 includes a hole-shaped portion 420 recessed toward the other side in the axial direction at a position of the one-side end surface 42, which is centered on the axial center CL.

The protrusion-shaped portion 110 of the housing 10 is inserted into the hole-shaped portion 420 provided on the one-side end surface 42 of the valve 40, and is rotatably supported by the inner wall of the hole-shaped portion 420. When the outer diameter of the protrusion-shaped portion 110 of the housing 10 is D4, the inner diameter of the hole-shaped portion 420 of the valve 40 is D5, and the outer diameter of the one-side end surface 42 of the valve 40 is D3, the relationships of D4<D3 and D5<D3 hold. Since D4 is slightly smaller than D5, the relationship of D4<D5<D3 holds. Thus, by reducing the radius of the sliding portion on which the protrusion-shaped portion 110 of the housing 10 and the hole-shaped portion 420 of the valve 40 slide, that is, D4 and D5, the sliding resistance of the sliding portion can be reduced, and torque during the rotational drive of the valve 40 can be reduced. The inner wall of the hole-shaped portion 420 is formed in parallel with the axial center CL, and allows the relative movement of the protrusion-shaped portion 110 in the axial direction. A distal end surface 111 on the other side in the axial direction of the protrusion-shaped portion 110 of the housing 10 and a bottom surface 421 on the other side in the axial direction of the hole-shaped portion 420 of the valve 40 have no contact with each other.

The fluid control valve of the fifth embodiment described above exerts the following effects.

(1) In the fifth embodiment, the valve 40 includes a hole-shaped portion 420 recessed in the axial direction at a position of the one-side end surface 42, which is centered on the axial center CL. The housing 10 includes the protrusion-shaped portion 110 that rotatably supports the hole-shaped portion 420 of the valve 40.

According to this, the protrusion-shaped portion 110 of the housing 10 rotatably supports the hole-shaped portion 420 of the valve 40, thereby preventing the positional displacement of the axial center CL of the valve 40. Therefore, the pressed state between the valve 40 and the seal can be stabilized, the side wall 41 of the valve 40 and the seal member 50 can be kept in sliding contact with each other with small sliding resistance, and sealability during both the rotation and stop of the valve 40 can be ensured.

(2) In the fifth embodiment, the inner diameter D5 of the hole-shaped portion 420 of the valve 40 and the outer diameter D4 of the protrusion-shaped portion 110 of the housing 10 are smaller than the outer diameter D3 of the one-side end surface 42 of the valve 40.

According to this, by reducing the radius of the sliding portion between the hole-shaped portion 420 of the valve 40 and the protrusion-shaped portion 110 of the housing 10, the sliding resistance of the sliding portion can be reduced, and torque during the rotational drive of the valve 40 can be reduced.

(3) In the fifth embodiment, the bottom surface 421 on the other side in the axial direction of the hole-shaped portion 420 of the valve 40 and the distal end surface 111 on the other side in the axial direction of the protrusion-shaped portion 110 of the housing 10 have no contact with each other.

According to this, it is possible to eliminate sliding at the locations of the hole-shaped portion 420 of the valve 40 and the protrusion-shaped portion 110 of the housing 10, which are not related to the function of preventing the positional displacement of the axial center CL of the valve 40, and to reduce torque during the rotational drive of the valve 40.

### Sixth Embodiment

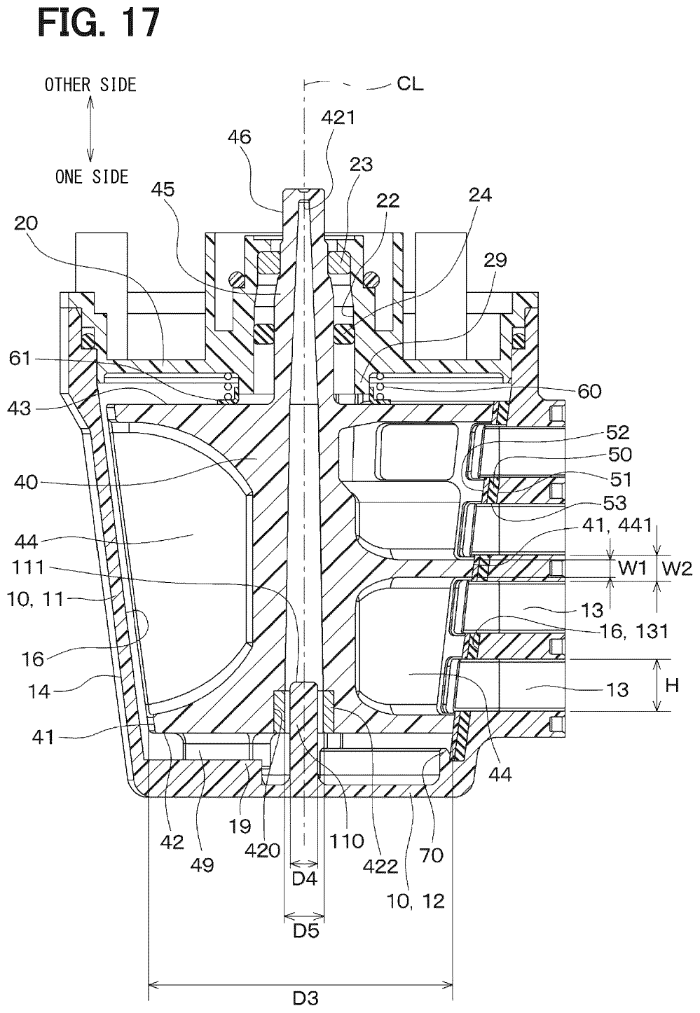

As illustrated in FIG. 17, the fluid control valve of the sixth embodiment includes a bearing 422 between the hole-shaped portion 420 of the valve 40 and the protrusion-shaped portion 110 of the housing 10. The bearing 422 is, for example, a sliding bearing, is fixed to the inside of the hole-shaped portion 420 of the valve 40, and slides on the protrusion-shaped portion 110 of the housing 10. The bearing 422 and the valve 40 are integrally molded by insert molding or two-color molding. Alternatively, the bearing 422 may be post-assembled inside the hole-shaped portion 420 of the valve 40 by outsert molding, press-fitting, or the like.

As the material of the bearing 422, for example, a material different from the material of the valve 40 or the housing 10, such as metal, may be used, as described in the second embodiment. Alternatively, when the same type of material as the material of the valve 40 or the housing 10 is used as the material of the bearing 422, at least one of PTFE, a fluororesin, and a high-lubricity material is blended. Alternatively, the bearing 422 may be a material with at least one of PTFE, a fluororesin, and a high-lubricity material applied to a metal surface or a resin surface.

The fluid control valve of the sixth embodiment described above exerts the following effects.

(1) The fluid control valve of the sixth embodiment includes the bearing 422 provided between the hole-shaped portion 420 of the valve 40 and the protrusion-shaped portion 110 of the housing 10.

According to this, the sliding resistance between the hole-shaped portion 420 of the valve 40 and the protrusion-shaped portion 110 of the housing 10 can be further reduced.

(2) In the sixth embodiment, the material of the valve 40 or the housing 10 differs from the material of the bearing 422.

According to this, as the material of the bearing 422, any material different from the valve 40 or the housing 10 can be selected.

(3) In the sixth embodiment, when the material of the bearing 422 is the same as the material of the valve 40 or the housing 10, at least one of PTFE, a fluororesin, and a high-lubricity material is blended.

According to this, the sliding resistance between the bearing 422 and the protrusion-shaped portion 110 of the housing 10 can be further reduced. The bearing 422 is specifically a sliding bearing.

(4) In the sixth embodiment, the bearing 422 may be a material with at least one of PTFE, a fluororesin, and a high-lubricity material applied to a metal surface or a resin surface.

This also makes it possible to further reduce the sliding resistance between the bearing 422 and the protrusion-shaped portion 110 of the housing 10. The bearing 422 is specifically a sliding bearing.

### Seventh Embodiment

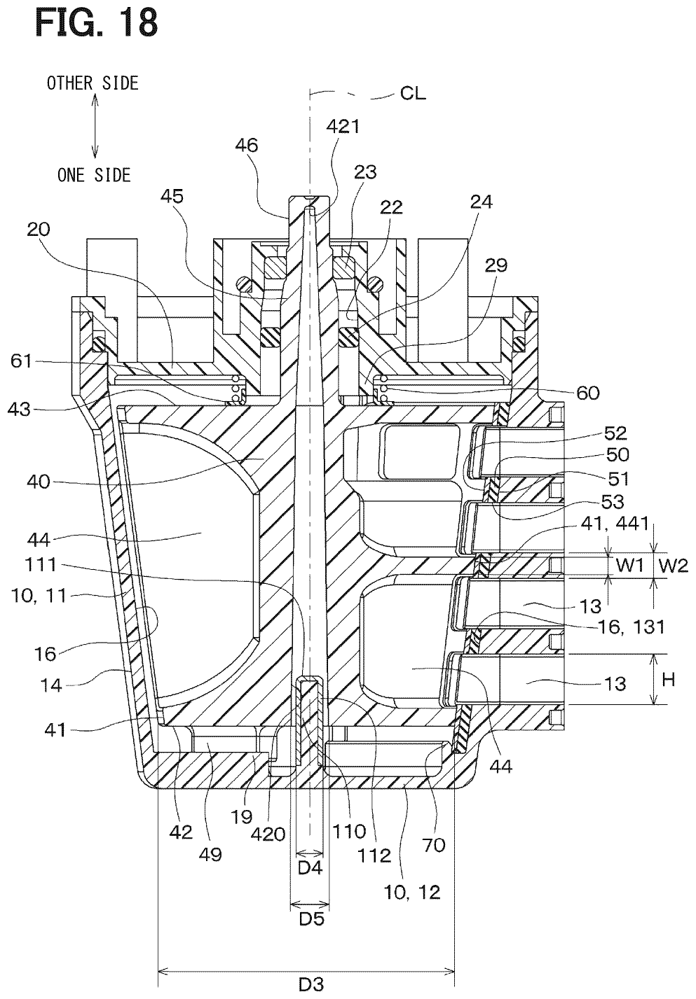

As illustrated in FIG. 18, the fluid control valve of the seventh embodiment also includes a bearing 112 between the hole-shaped portion 420 of the valve 40 and the protrusion-shaped portion 110 of the housing 10. The bearing 112 is, for example, a sliding bearing, is fixed to the outside of the protrusion-shaped portion 110 of the housing 10, and slides on the inner wall of the hole-shaped portion 420 of the valve 40. The bearing 112 and the housing 10 are integrally molded by insert molding or two-color molding. Alternatively, the bearing 112 may be post-assembled to the outside of the protrusion-shaped portion 110 of the housing 10 by outsert molding, press-fitting, or the like.

As the material of the bearing 112, the same material as those described in the second and sixth embodiments can be used.

The fluid control valve of the seventh embodiment described above can also exert the same effects as those of the sixth embodiment.

### Eighth Embodiment

An eighth embodiment will be described. The eighth embodiment differs from the first embodiment and the like in the method of fixing the actuator 30, the cover 20, and the housing 10, while the others are the same as those of the first embodiment and the like, and therefore, only the part that differs from the first embodiment and the like will be described.

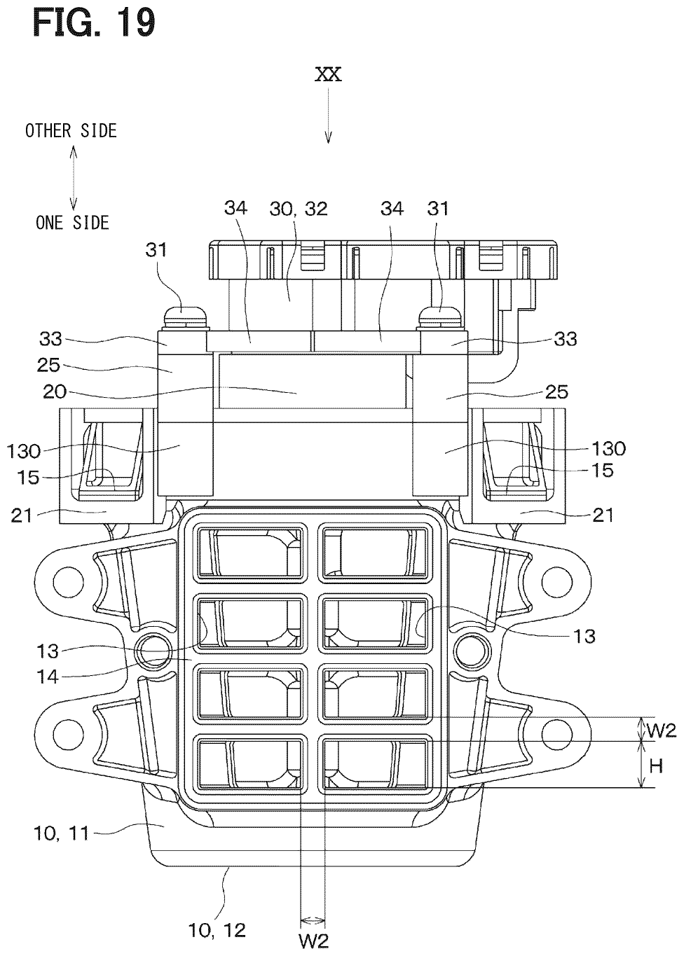

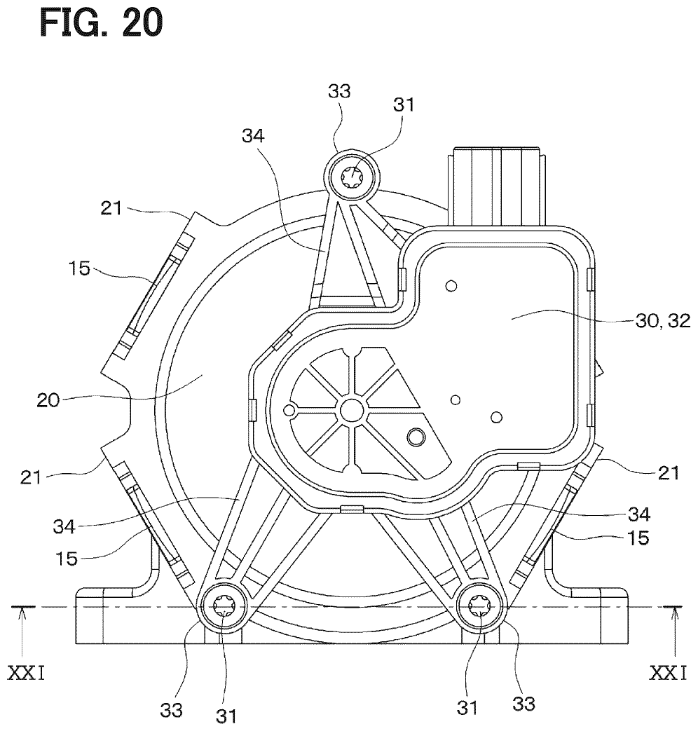

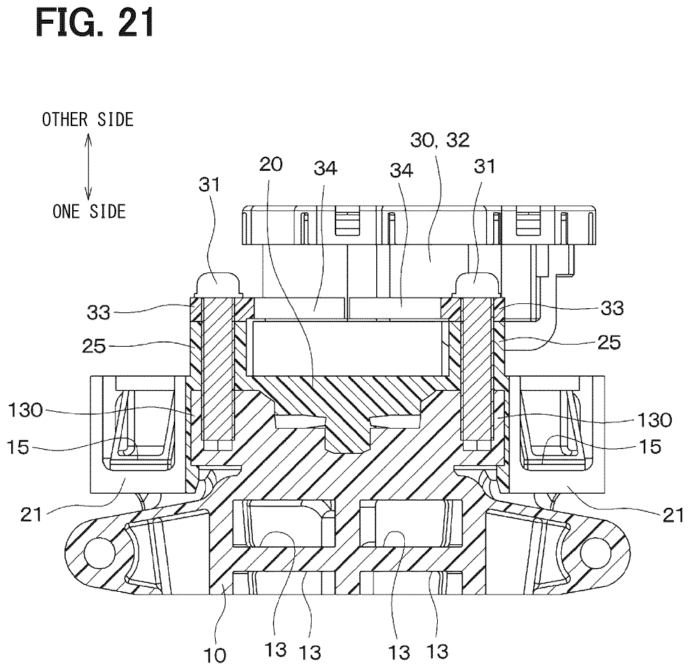

As illustrated in FIGS. 19 to 21, in the eighth embodiment, the actuator 30 and the cover 20 are fixed to the housing 10 by the same screw 31. For example, a tapping screw is used as the screw 31. The housing 10 includes a housing-side screw receiving portion 130 for attaching the screw 31 at a position outward in the radial direction from the inner wall 16 of the cylinder 11. The cover 20 includes a cover-side screw receiving portion 25 at a position overlapping with the housing-side screw receiving portion 130 in the axial direction. The actuator 30 also includes an actuator-side screw receiving portion 33 at a position overlapping the housing-side screw receiving portion 130 and the cover-side screw receiving portion 25 in the axial direction. The case 32 and the actuator-side screw receiving portion 33 of the actuator 30 are connected by an arm 34. In such a configuration, the housing-side screw receiving portion 130, the cover-side screw receiving portion 25, and the actuator-side screw receiving portion 33 overlap in the axial direction, and are fastened and fixed together by the screw 31.

The fluid control valve of the eighth embodiment described above exerts the following effects.

In the eighth embodiment, the actuator 30, the cover 20, and the housing 10 are fixed by the same screw 31.

According to this, the number of parts necessary for assembling and fixing the actuator 30 and the cover 20 to the housing 10 can be reduced.

### Ninth Embodiment

The ninth embodiment differs from the first embodiment and the like in the shape of the flow path 44 of the valve 40, while the others are the same as those in the first embodiment and the like, and thus only the part that differs from the first embodiment and the like will be described.

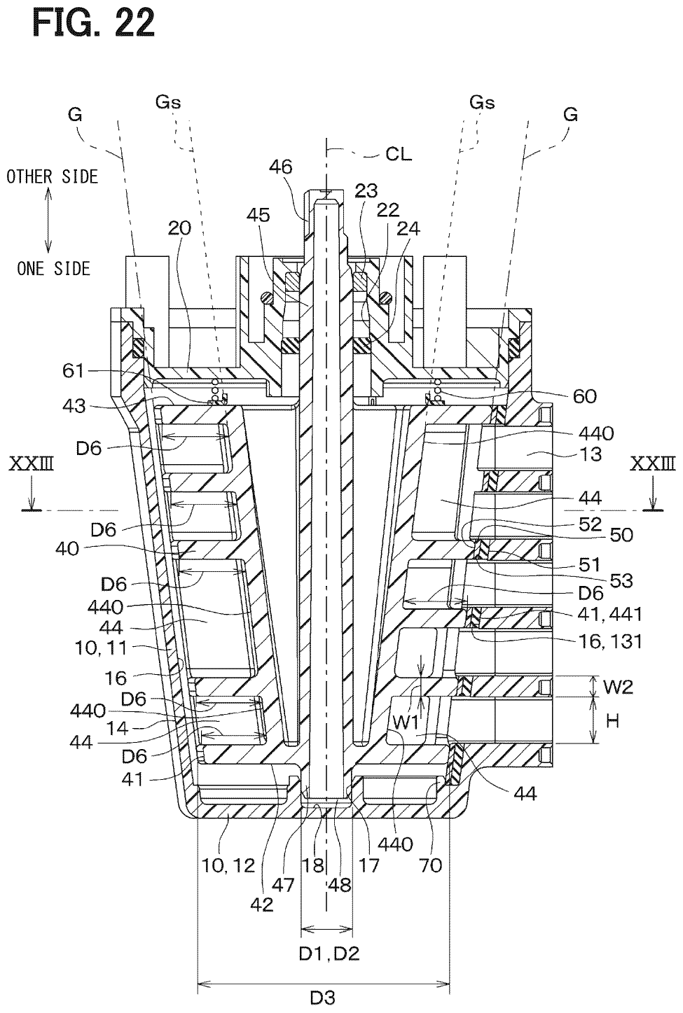

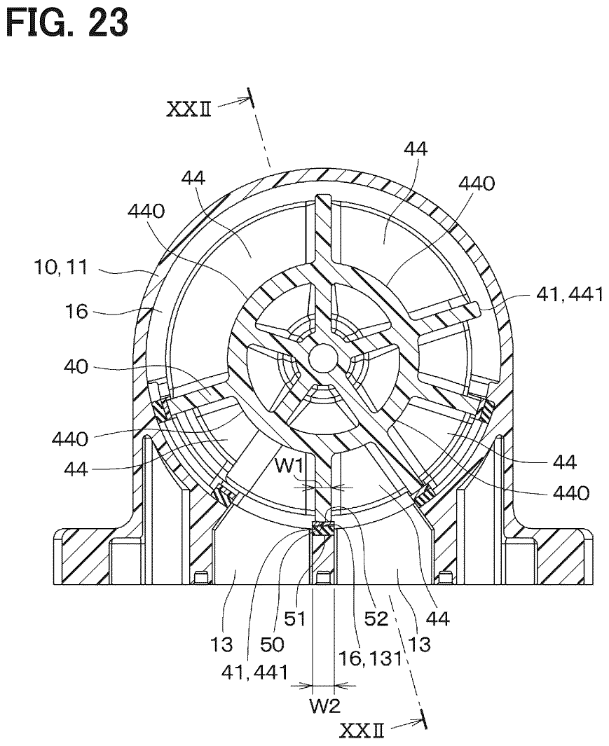

As illustrated in FIGS. 22 and 23, in the ninth embodiment, a deep portion 440 on the axial center CL side of the plurality of flow paths 44 included in the valve 40 is shaped along a side surface of a conical shape similar to and coaxial with the conical shape along which the side wall 41 of the valve 40 extends. In FIG. 22, a part of the generatrix G of the conical shape, along which the side wall 41 of the valve 40 extends, is indicated by a dash-dot line, and a generatrix Gs of the conical shape, along which the deep portion 440 on the axial center CL side of each of the plurality of flow paths 44 extends, is indicated by a dashed line. Thus, the deep portions 440 of the plurality of flow paths 44 of the valve 40 and the side wall 41 of the valve 40 are formed in parallel. Therefore, for each of the plurality of flow paths 44 arranged in the axial direction, a distance D6 between the deep portion 440 on the axial center CL side of the flow path 44 and the side wall 41 is uniform.

The fluid control valve of the ninth embodiment described above exerts the following effects.

In the ninth embodiment, it is possible to reduce a phenomenon peculiar to a conical valve in which the depth width of the flow path 44 decreases as the outer diameter of the valve 40 decreases toward one side in the axial direction of the valve 40. That is, for the plurality of flow paths 44 included in the valve 40, the distance D6 between the deep portion 440 on the axial center CL side of the flow path 44 and the side wall 41 can be made uniform. Therefore, the pressure loss of the fluid flowing through each of the plurality of flow paths 44 can be made uniform, and water permeability can be ensured.

### Tenth Embodiment

The tenth embodiment differs from the first embodiment and the like in the method of installing the spring guide 61, while the others are the same as those in the first embodiment and the like, and thus only the part that differs from the first embodiment and the like will be described.

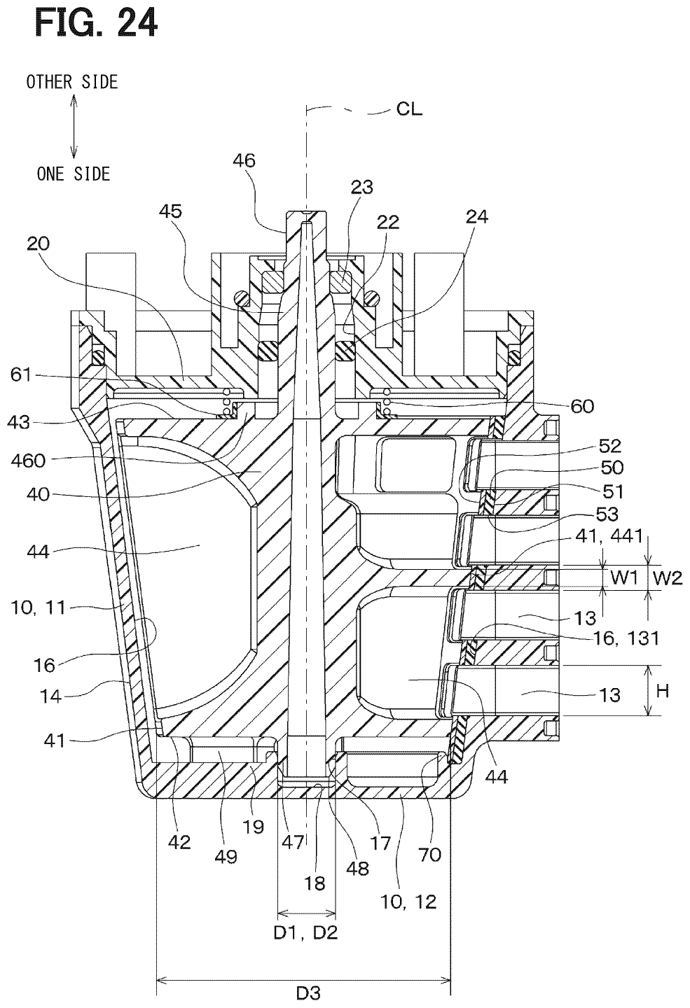

As illustrated in FIG. 24, in the tenth embodiment, a protruding portion 460 protruding to the other side in the axial direction is provided on the other-side end surface 43 of the valve 40. The protruding portion 460 is provided inward in the radial direction of the spring guide 61.

The spring guide 61 has an L-shaped cross-section parallel to the axial center CL, and includes an inner surface in the radial direction in sliding contact with the protruding portion 460 provided on the other-side end surface 43 of the valve 40 and a surface on one side in the axial direction in sliding contact with the other-side end surface 43 of the valve 40. Even with such a configuration, the spring guide 61 can prevent the axial displacement of the spring 60 and transmit the biasing force of the spring 60 to the valve 40.

The fluid control valve of the tenth embodiment described above can also exert the same effects as those of the first to ninth embodiments.

### Eleventh Embodiment

An eleventh embodiment will be described. The eleventh embodiment differs from the first and eighth embodiments and the like in the method of fixing the actuator 30, the cover 20, and the housing 10, and the others are the same as those of the first and eighth embodiments and the like. Therefore, only the part that differs from the first and eighth embodiments and the like will be described.

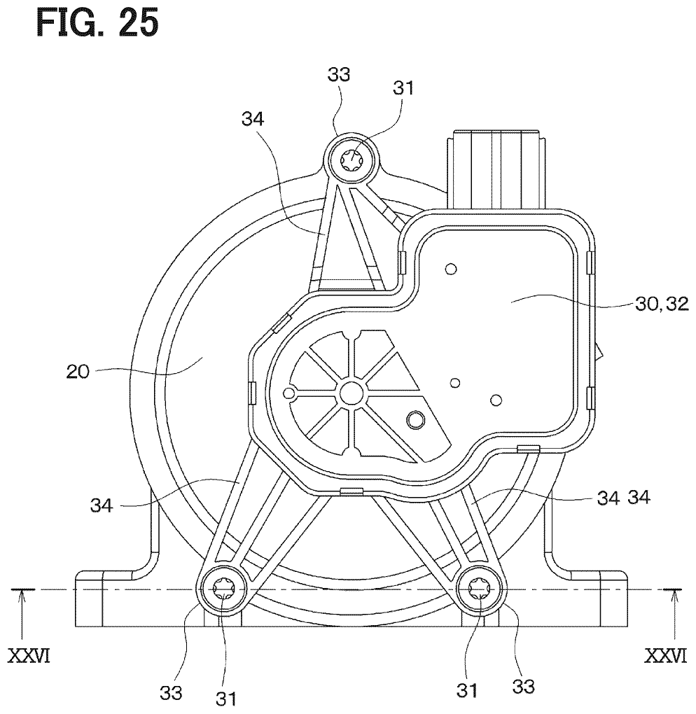

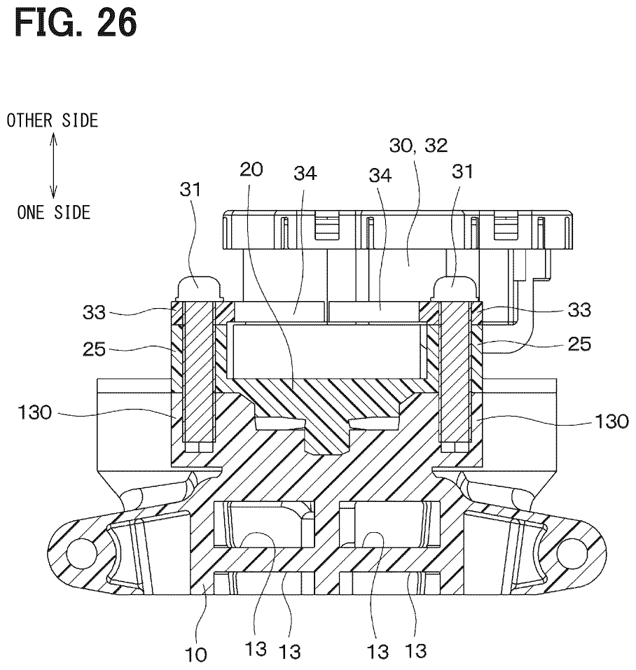

As illustrated in FIGS. 25 and 26, in the eleventh embodiment, the actuator 30 and the cover 20 are fixed to the housing 10 by the same screw 31, as in the eighth embodiment. That is, the housing-side screw receiving portion 130, the cover-side screw receiving portion 25, and the actuator-side screw receiving portion 33 overlap in the axial direction, and are fastened and fixed together by the screws 31.

Here, in the eleventh embodiment, the snap-fit for fixing the cover 20 and the housing 10 described in the first and eighth embodiments and the like is eliminated. As described above, when the actuator 30 and the cover 20 are fixed to the housing 10 by the same screw 31, there may be no snap-fit for fixing the cover 20 and the housing 10.

The fluid control valve of the eleventh embodiment described above can simplify the fixing of the actuator 30, the cover 20, and the housing 10.

### Other Embodiments

(1) In each of the above embodiments, the biasing member has been described as a compression coil spring, but the present disclosure is not limited thereto, and for example, the biasing member may be rubber, a disc spring, or the like.

(2) In each of the above embodiments, the number of ports 13 has been described as eight, but the present disclosure is not limited thereto, and the number of ports 13 can be set arbitrarily. The shape of the flow path 44 of the valve 40 can also be set arbitrarily.

(3) In each of the above embodiments, it has been described that the material of the spring guide 61 differs from the material of the valve 40, but the present disclosure is not limited thereto, and for example, the material of the spring guide 61 and the material of the valve 40 may be the same or the same type.

(4) In each of the above embodiments, the seal member 50 has been described assuming that the material of the portion on the housing 10 side differs from the material of the portion on the valve 40 side, but the present disclosure is not limited thereto. For example, in the seal member 50, the material of the portion on the housing 10 side and the material of the portion on the valve 40 side may be the same or the same type.

The present disclosure is not limited to the embodiments described above, and can be appropriately changed. Each of the above embodiments and a part thereof are not unrelated to each other, and can be appropriately combined unless the combination is obviously impossible. It goes without saying that in each of the above embodiments, the elements constituting the embodiment are not necessarily essential except for a case where it is explicitly stated that the elements are particularly essential and a case where the elements are considered to be obviously essential in principle. In the above embodiments, when a numerical value such as the number, a numerical value, an amount, or a range of the constituent elements of the embodiment is mentioned, the numerical value is not limited to specific numerical values unless otherwise specified as being essential or obviously limited to the specific numerical values in principle. In each of the above embodiments, when the shapes, positional relationships, and the like of the constituent elements and the like are referred to, the shapes, positional relationships, and the like are not limited thereto unless otherwise specified or limited to specific shapes, positional relationships, and the like in principle.

### View Points of the Present Disclosure

The present disclosure described above can be understood, for example, from the following viewpoints.

### View Point 1

A fluid control valve includes: a valve (40) having a side wall (41) along a side surface in a conical shape and a flow path (44) recessed from the side wall toward an axis of the side wall in the conical shape; a housing (10) rotatably accommodating the valve about an axial center (CL) of rotation that is the axis of the conical shape, the housing having a port (13) that passes through an outer wall (14) and an inner wall (16); a seal member (50) provided between the inner wall of the housing and the valve, the seal member having a surface (51) on a housing side and in contact with a port periphery (131) of the inner wall of the housing and a surface (52) on the valve side in sliding contact with a side wall of the valve; and a biasing member (60) biasing the valve toward an apex of the conical shape of the valve. The biasing member is configured to, during both rotation and stop of the valve, keep the side wall of the valve and the seal member in sliding contact with each other, and keep the inner wall of the housing and the seal member in contact with each other.

### View Point 2

The fluid control valve according to the view point 1, in which in the seal member, a material of a portion on the housing side differs from a material of a portion on the valve side.

### View Point 3

The fluid control valve according to the view point 1 or 2, in which the biasing member is a spring, the fluid control valve includes a spring guide (61) provided between the valve and the spring, and the spring guide supports the spring and transmits a biasing force of the spring to the valve.

### View Point 4

The fluid control valve according to the view point 3, in which a material of the spring guide differs from a material of the valve.

### View Point 5

The fluid control valve according to the view point 3 or 4, in which the material of the spring guide is at least one of a material with polytetrafluoroethylene applied to a metal surface, a material with a fluororesin applied to a metal surface, a material with a high-lubricity material applied to a metal surface, a material with polytetrafluoroethylene applied to a resin surface, a material with a fluororesin applied to a resin surface, and a material with a high-lubricity material applied to a resin surface.

### View Point 6

The fluid control valve according to any one of the view points 1 to 5, in which the valve has a one-side end surface (42) on an apex side of the conical shape, an other-side end surface (43) on an opposite side of the one-side end surface and on a bottom surface side of the conical shape, and a protrusion (47) protruding in an axial direction from a position of the one-side end surface centered on the axial center, and the housing has a cylinder (11) provided outward in a radial direction from the valve, a bottom (12) facing the one-side end surface and closing a one-side end portion of the cylinder, and a hole (17) rotatably supporting the protrusion.

### View Point 7

The fluid control valve according to the view point 6, in which an outer diameter (D1) of the protrusion and an inner diameter (D2) of the hole are smaller than an outer diameter (D3) of the one-side end surface.

### View Point 8

The fluid control valve according to the view point 6 or 7, in which a distal end surface (48) of the protrusion on one side in the axial direction and a bottom surface (18) of the hole on one side in the axial direction have no contact with each other.

### View Point 9

The fluid control valve according to the any one of the view points 6 to 8, further includes: a bearing (171, 471) provided between the protrusion and the hole.

### View Point 10

The fluid control valve according to the view point 9, in which a material of the valve or the housing differs from a material of the bearing.

### View Point 11

The fluid control valve according to the view point 9, in which a material of the bearing is a same type as a material of the valve or the housing, and is obtained by blending at least one of polytetrafluoroethylene, a fluororesin, and a high-lubricity material.

### View Point 12

The fluid control valve according to the view point 9 or 10, in which the bearing is a material with at least one of polytetrafluoroethylene, fluororesin, and a high-lubricity material applied to a metal surface.

### View Point 13

The fluid control valve according to any one of the view points 6 to 12, in which the protrusion is a part of a shaft (410) insert-molded in a valve body (400) that forms the flow path.

### View Point 14

The fluid control valve according to any one of the view points 1 to 5, in which the valve has a one-side end surface (42) on the apex side of the conical shape, an other-side end surface (43) facing the one-side end surface and on a bottom surface side of the conical shape, and a hole-shaped portion (420) recessed in an axial direction and at a position in the one-side end surface centered on the axial center, and the housing has a cylinder (11) provided outward in a radial direction from the valve, a bottom (12) facing the one-side end surface and closes the one-side end portion of the cylinder, and a protrusion-shaped portion (110) rotatably supporting the hole-shaped portion.

### View Point 15

The fluid control valve according to the view point 14, in which an inner diameter (D5) of the hole-shaped portion and an outer diameter (D4) of the protrusion-shaped portion are smaller than an outer diameter (D3) of the one-side end surface.

### View Point 16

The fluid control valve according to the view point 14 or 15, in which a bottom surface (421) on the other side in the axial direction of the hole-shaped portion and a distal end surface (111) on the other side in the axial direction of the protrusion-shaped portion have no contact with each other.

### View Point 17

The fluid control valve according to any one of the view points 14 to 16, further includes: a bearing (422, 112) provided between the hole-shaped portion and the protrusion-shaped portion.

### View Point 18

The fluid control valve according to the view point 17, in which a material of the valve or the housing differs from a material of the bearing.

### View Point 19

The fluid control valve according to the view point 17, in which a material of the bearing is a same type as a material of the valve or the housing, and is obtained by blending at least one of polytetrafluoroethylene, a fluororesin, and a high-lubricity material.

### View Point 20

The fluid control valve according to the view point 17 or 18, in which the bearing is a material with at least one of polytetrafluoroethylene, fluororesin, and a high-lubricity material applied to a metal surface.

### View Point 21

The fluid control valve according to any one of the view points 1 to 20, in which a flow path periphery of the side wall of the valve (441) in sliding contact with the seal member has a width W1, a port periphery (131) of the inner wall of the housing that is in contact with the seal member has a width W2, and both W1 and W2 are 2 mm or more.

### View Point 22

The fluid control valve according to any one of the view points 1 to 21, in which a flow path periphery of the side wall of the valve that is in sliding contact with the seal member has a width W1, a port periphery of the inner wall of the housing that is in contact with the seal member has a width W2, and a relationship of W2≥W1 holds.

### View Point 23

The fluid control valve according to any one of the view points 1 to 22, in which a radius of curvature (R) of a flow path periphery of the side wall of the valve that is in sliding contact with the seal member is same as or larger than a radius of curvature of a valve-side surface of the seal member at a same position in the axial-center direction.

### View Point 24

The fluid control valve according to any one of the view points 1 to 23, in which torque required for rotating the valve with respect to the housing and the seal member is 2.0 N·m or less.

### View Point 25

The fluid control valve according to any one of the view points 1 to 24, in which an internal angle (θ) formed by a generatrix (G) of the conical shape, along which the side wall of the valve extends, and the axial center of the valve is 5 deg or more.

### View Point 26

The fluid control valve according to any one of the view points 1 to 25, in which the housing includes a cylinder (11) provided outward in a radial direction from the valve and a bottom (12) that closes a one-side end portion of the cylinder, and an inner wall of the cylinder is along a side surface of a conical shape similar to and coaxial with the conical shape along which the side wall of the valve extends.

### View Point 27

The fluid control valve according to any one of the view points 1 to 26, in which the valve includes an input shaft (45) protruding in the axial direction from an other-side end surface on a bottom surface side of the conical shape and to which torque is input, the housing includes a cylinder (11) provided outward in a radial direction from the valve and a bottom (12) that closes a one-side end portion of the cylinder, the fluid control valve includes a cover (20) that closes an opening on the other side of the cylinder and has an insertion hole (22) through which the input shaft is inserted, and a shaft seal member (24) provided inside the insertion hole and configured to prevent fluid leakage from a gap between an inner wall of the insertion hole and the input shaft, and the valve, the seal member, and the cover are removable from the housing from the other side in the axial direction.

### View Point 28

The fluid control valve according to the view point 27, in which the cover is fixed to the housing by a snap-fit (21).

### View Point 29

The fluid control valve according to the view point 27 or 28, further includes: an actuator (30) configured to input torque to the input shaft of the valve, in which the actuator and the cover are fixed to the housing by a same screw (31).

### View Point 30

The fluid control valve according to any one of the view points 1 to 29, in which the valve includes a stopper (49) protruding, to one side in the axial direction at a position away from the axial center, from the one-side end surface on the apex side of the conical shape, and the housing includes a stopper contact portion (19) receiving the stopper.

### View Point 31

The fluid control valve according to the view point 30, in which the housing includes a cylinder (11) provided outward in a radial direction from the valve and a bottom (12) that closes a one-side end portion of the cylinder, and the stopper contact portion is provided on the bottom.

### View Point 32

The fluid control valve according to any one of the view points 1 to 31, in which the valve includes a plurality of the flow paths arranged in an axial-center direction, and a deep portion (441) on an axial center side of the plurality of the flow paths is shaped along a side surface of a conical shape that is similar to and coaxial with the conical shape along which the side wall of the valve extends.

### View Point 33

The fluid control valve according to any one of the view points 1 to 32, in which the valve includes a plurality of the flow paths arranged in an axial-center direction, and a distance (D6) between the side wall and a deep portion on the axial center side of each of the plurality of the flow paths is uniform.

What is claimed is:

1. A fluid control valve comprising:
a valve having a side wall along a side surface in a conical shape and a flow path recessed from the side wall toward an axis of the side wall in the conical shape;
a housing rotatably accommodating the valve about an axial center of rotation that is the axis of the conical shape, the housing having a port that passes through an outer wall and an inner wall;
a seal member provided between the inner wall of the housing and the valve, the seal member having a surface on a housing side and in contact with a port periphery of the inner wall of the housing and a surface on the valve side in sliding contact with a side wall of the valve; and
a biasing member biasing the valve toward an apex of the conical shape of the valve and, wherein
the biasing member is configured to, during both rotation and stop of the valve, keep the side wall of the valve and the seal member in sliding contact with each other, and keep the inner wall of the housing and the seal member in contact with each other.

2. The fluid control valve according to claim 1, wherein
in the seal member, a material of a portion on the housing side differs from a material of a portion on the valve side.

3. The fluid control valve according to claim 1, wherein
the biasing member is a spring,
the fluid control valve includes a spring guide provided between the valve and the spring, and
the spring guide supports the spring and transmits a biasing force of the spring to the valve.

4. The fluid control valve according to claim 3, wherein
a material of the spring guide differs from a material of the valve.

5. The fluid control valve according to claim 3, wherein
the material of the spring guide is at least one of
a material with polytetrafluoroethylene applied to a metal surface, a material with a fluororesin applied to a metal surface,
a material with a high-lubricity material applied to a metal surface, a material with polytetrafluoroethylene applied to a resin surface,
a material with a fluororesin applied to a resin surface, or
a material with a high-lubricity material applied to a resin surface.

6. The fluid control valve according to claim 1, wherein
the valve has
a one-side end surface on an apex side of the conical shape,
an other-side end surface on an opposite side of the one-side end surface and on a bottom surface side of the conical shape, and
a protrusion protruding in an axial direction from a position of the one-side end surface centered on the axial center, and
the housing has
a cylinder provided outward in a radial direction from the valve,
a bottom facing the one-side end surface and closing a one-side end portion of the cylinder, and
a hole rotatably supporting the protrusion.

7. The fluid control valve according to claim 6, wherein
an outer diameter of the protrusion and an inner diameter of the hole are smaller than an outer diameter of the one-side end surface.

8. The fluid control valve according to claim 6, wherein
a distal end surface of the protrusion on one side in the axial direction and a bottom surface of the hole on one side in the axial direction have no contact with each other.

9. The fluid control valve according to claim 6, further comprising:
a bearing provided between the protrusion and the hole.

10. The fluid control valve according to claim 9, wherein
a material of the valve or the housing differs from a material of the bearing.

11. The fluid control valve according to claim 9, wherein
a material of the bearing is a same type as a material of the valve or the housing, and is obtained by blending at least one of polytetrafluoroethylene, a fluororesin, and a high-lubricity material.

12. The fluid control valve according to claim 9, wherein
the bearing is a material with at least one of polytetrafluoroethylene, fluororesin, or a high-lubricity material applied to a metal surface.

13. The fluid control valve according to claim 6, wherein
the protrusion is a part of a shaft insert-molded in a valve body that forms the flow path.

14. The fluid control valve according to claim 1, wherein
the valve has
a one-side end surface on the apex side of the conical shape,
an other-side end surface facing the one-side end surface and on a bottom surface side of the conical shape, and
a hole-shaped portion recessed in an axial direction and at a position in the one-side end surface centered on the axial center, and
the housing has
a cylinder provided outward in a radial direction from the valve,
a bottom facing the one-side end surface and closes the one-side end portion of the cylinder, and
a protrusion-shaped portion rotatably supporting the hole-shaped portion.

15. The fluid control valve according to claim 14, wherein
an inner diameter of the hole-shaped portion and an outer diameter of the protrusion-shaped portion are smaller than an outer diameter of the one-side end surface.

16. The fluid control valve according to claim 14, wherein
a bottom surface on the other side in the axial direction of the hole-shaped portion and a distal end surface on the other side in the axial direction of the protrusion-shaped portion have no contact with each other.

17. The fluid control valve according to claim 14, further comprising:
a bearing provided between the hole-shaped portion and the protrusion-shaped portion.

18. The fluid control valve according to claim 17, wherein
a material of the valve or the housing differs from a material of the bearing.

19. The fluid control valve according to claim 17, wherein
a material of the bearing is a same type as a material of the valve or the housing, and is obtained by blending at least one of polytetrafluoroethylene, a fluororesin, or a high-lubricity material.

20. The fluid control valve according to claim 17, wherein
the bearing is a material with at least one of polytetrafluoroethylene, fluororesin, or a high-lubricity material applied to a metal surface.

21. The fluid control valve according to claim 1, wherein
a flow path periphery of the side wall of the valve in sliding contact with the seal member has a width W1,
a port periphery of the inner wall of the housing that is in contact with the seal member has a width W2, and
both W1 and W2 are 2 mm or more.

22. The fluid control valve according to claim 1, wherein
a flow path periphery of the side wall of the valve that is in sliding contact with the seal member has a width W1,
a port periphery of the inner wall of the housing that is in contact with the seal member has a width W2, and
a relationship of W2≥W1 holds.

23. The fluid control valve according to claim 1, wherein
a radius of curvature of a flow path periphery of the side wall of the valve that is in sliding contact with the seal member is same as or larger than a radius of curvature of a valve-side surface of the seal member at a same position in the axial-center direction.

24. The fluid control valve according to claim 1, wherein
torque required for rotating the valve with respect to the housing and the seal member is 2.0 N·m or less.

25. The fluid control valve according to claim 1, wherein
an internal angle formed by a generatrix of the conical shape, along which the side wall of the valve extends, and the axial center of the valve is 5 deg or more.

26. The fluid control valve according to claim 1, wherein
the housing includes a cylinder provided outward in a radial direction from the valve and a bottom that closes a one-side end portion of the cylinder, and
an inner wall of the cylinder is along a side surface of a conical shape similar to and coaxial with the conical shape along which the side wall of the valve extends.

27. The fluid control valve according to claim 1, wherein
the valve includes an input shaft protruding in the axial direction from an other-side end surface on a bottom surface side of the conical shape and to which torque is input,
the housing includes a cylinder provided outward in a radial direction from the valve and a bottom that closes a one-side end portion of the cylinder,
the fluid control valve includes a cover that closes an opening on the other side of the cylinder and has an insertion hole through which the input shaft is inserted, and a shaft seal member provided inside the insertion hole and configured to prevent fluid leakage from a gap between an inner wall of the insertion hole and the input shaft, and
the valve, the seal member, and the cover are removable from the housing from the other side in the axial direction.

28. The fluid control valve according to claim 27, wherein
the cover is fixed to the housing by a snap-fit.

29. The fluid control valve according to claim 27, further comprising:
an actuator configured to input torque to the input shaft of the valve, wherein
the actuator and the cover are fixed to the housing by a same screw.

30. The fluid control valve according to claim 1, wherein
the valve includes a stopper protruding, to one side in the axial direction at a position away from the axial center, from the one-side end surface on the apex side of the conical shape, and
the housing includes a stopper contact portion receiving the stopper.

31. The fluid control valve according to claim 30, wherein
the housing includes a cylinder provided outward in a radial direction from the valve and a bottom that closes a one-side end portion of the cylinder, and
the stopper contact portion is provided on the bottom.

32. The fluid control valve according to claim 1, wherein
the valve includes a plurality of the flow paths arranged in an axial-center direction, and
a deep portion on an axial center side of the plurality of the flow paths is shaped along a side surface of a conical shape that is similar to and coaxial with the conical shape along which the side wall of the valve extends.

33. The fluid control valve according to claim 1, wherein
the valve includes a plurality of the flow paths arranged in an axial-center direction, and
a distance between the side wall and a deep portion on the axial center side of each of the plurality of the flow paths is uniform.
